(19) United States
(12) Patent Application Publication
(10) Pub. No.: US 2024/0270589 A1
(43) Pub. Date: Aug. 15, 2024

(54) METAL-CARBON COMPOSITE BODIES AND RELATED METHODS

(71) Applicant: The United States of America, as Represented by the Secretary of Agriculture, Washington, DC (US)

(72) Inventors: Zhiyong Cai, Madison, WI (US); Qiangu Yan, Madison, WI (US)

(21) Appl. No.: 18/431,086

(22) Filed: Feb. 2, 2024

Related U.S. Application Data
(60) Provisional application No. 63/444,291, filed on Feb. 9, 2023.

(51) Int. Cl. C01D 13/00; H01G 11/34

(52) U.S. Cl. CPC C01D 13/00; C01P 2002/72; C01P 2002/85; C01P 2004/03; C01P 2004/51; C01P 2006/17; C01P 2006/40; H01G 11/34

(57) ABSTRACT

Methods of forming a metal-carbon composite body are provided which may comprise (a) subjecting a metallized biomass to pressure for a period of time to provide a compressed metallized biomass body, wherein the metallized biomass comprises a metallized biopolymer comprising a hydrocarbon backbone and a plurality of metallized functional groups distributed along the hydrocarbon backbone and covalently bound thereto; and (b) heating the compressed metallized biomass body according to a heating profile to carbonize the compressed metallized biomass body and provide a metal-carbon composite body comprising a covalently bound carbon matrix that extends in three dimensions to form a three-dimensional (3D) carbon network with metal distributed throughout the 3D carbon network. The metal-carbon composite bodies are also provided.

### CROSS-REFERENCE TO RELATED APPLICATIONS

The present application claims the priority benefit of U.S. Provisional Patent App. No. 63/444,291 filed on Feb. 9, 2023, the entire disclosure of which is incorporated by reference herein.

### BACKGROUND

Metal-carbon composites find use in a variety of applications. Processing techniques for forming metal-carbon composites include powder metallurgy, metal infiltration, chemical vapor deposition (CVD), layer-by-layer assembly, electrochemical deposition, cold spraying, preform impregnation, accumulative roll bonding, carbothermal processes, and sol-gel methods. Pre-structured carbon materials are often used to form the metal-carbon composites including carbon nanotubes, carbon fibers, activated carbon, carbon black, carbon foams, and diamond-like carbon. The metal is often added to these carbon materials in particulate form.

### SUMMARY

Provided are methods of forming metal-carbon composite bodies from metallized biomass, e.g., metallized lignin. The metal-carbon composite bodies and articles of manufacture and devices incorporating the metal-carbon composite bodies are also provided.

In an embodiment 1, a method of forming a metal-carbon composite body comprises: (a) subjecting a metallized biomass to pressure for a period of time to provide a compressed metallized biomass body, wherein the metallized biomass comprises a metallized biopolymer comprising a hydrocarbon backbone and a plurality of metallized functional groups distributed along the hydrocarbon backbone and covalently bound thereto; and (b) heating the compressed metallized biomass body according to a heating profile to carbonize the compressed metallized biomass body and provide a metal-carbon composite body comprising a covalently bound carbon matrix that extends in three dimensions to form a three-dimensional (3D) carbon network with metal distributed throughout the 3D carbon network.

An embodiment 2 is the method of embodiment 1, wherein the metallized biopolymer comprises metallized lignin.

An embodiment 3 is the method of any of embodiments 1-2, wherein the metallized functional groups have formula —OM, wherein M is the metal.

An embodiment 4 is the method of any of embodiments 1-3, wherein the metallized functional groups comprise a metal selected from alkali metals.

An embodiment 5 is the method of any of embodiments 1-4, wherein the metallized functional groups comprise Na.

An embodiment 6 is the method of any of embodiments 1-5, wherein the method further comprises forming the metallized biomass by combining biomass comprising a biopolymer comprising the hydrocarbon backbone and a plurality of biomass functional groups distributed along the hydrocarbon backbone and covalently bound thereto, and a source of metal cations under conditions to induce reactions between the plurality of biomass functional groups and the metal cations to provide the plurality of metallized functional groups of the metallized biopolymer.

An embodiment 7 is the method of embodiment 6, wherein the source of the metal cations is a metal hydroxide.

An embodiment 8 is the method of any of embodiments 6-7, wherein the biomass and the source of metal cations are provided in a liquid medium.

An embodiment 9 is the method of any of embodiments 6-8, wherein the liquid medium comprises water.

An embodiment 10 is the method of embodiment 6, wherein the biomass is lignin, the metal cations comprise Na, and the biomass and the source of metal cations are provided in a liquid medium comprising water.

An embodiment 11 is the method of embodiment 10, wherein the lignin is kraft lignin.

An embodiment 12 is the method of any of embodiments 1-10, the method further comprising exposing the metal-carbon composite body to a reactant under conditions to induce a reaction between the metal and reactant to convert the metal to a metal-containing compound.

An embodiment 13 is the method of embodiment 12, wherein the metal-containing compound is a metal hydroxide, a metal oxide, a metal carbonate, or combinations thereof.

An embodiment 14 is the method of any of embodiments 1-13, wherein the metal forms a 3D metallic network intertwined with the 3D carbon network.

An embodiment 15 is the method of any of embodiments 1-14, wherein the 3D carbon network defines a plurality of pores distributed throughout that are at least partially filled with the metal.

An embodiment 16 is the method of embodiment 15, wherein a majority of pores in the 3D carbon network have a cross-sectional diameter of less than 100 nm.

An embodiment 17 is the method of embodiment 16, wherein the 3D carbon network is free of pores having a cross-sectional diameter of greater than 200 mm.

An embodiment 18 is the method of any of embodiments 1-17, wherein the metal is present at an amount of at least 10 weight % as compared to a total weight of the metal-carbon composite body.

In an embodiment 19, a metal-carbon composite body comprises a covalently bound carbon matrix that extends in three dimensions to form a three-dimensional (3D) carbon network with metal distributed throughout the 3D carbon network, wherein the metal forms a 3D metallic network intertwined with the 3D carbon network.

An embodiment 20 is an electrochemical device comprising an electrode comprising the metal-carbon composite body according to embodiment 19.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIG. 1 illustrates some of the steps in a method of forming a metal-carbon composite body according to an illustrative embodiment.

FIG. 2 shows the chemical structure of a portion of a softwood lignin molecule.

FIG. 3 is a schematic of an electrochemical device comprising an electrode comprising (or consisting of) any of the disclosed metal-carbon composite bodies.

FIGS. 4A-4D: Morphology of a Na-carbon composite body (LCF #3) and comparative body (LCF #1) formed from unmetallized kraft lignin. FIGS. 4A-4B show SEM images of LCF #1. FIGS. 4C-4D show SEM images of LCF #3.

FIGS. 5A-5I: Structure and surface characterization of LCF #1 and LCF #3. FIG. 5A shows XRD spectra, FIG. 5B shows N₂ adsorption/desorption isotherms, FIG. 5C shows pore size distributions as determined from density functional theory (DFT). FIG. 5D shows a full scale XPS survey with FIGS. 5E-5F showing the deconvolution of the C Is core level spectra. FIGS. 5G-5I show XPS spectra of Na, O, and S, respectively.

FIGS. 6A-6I: Electrochemical performance of LCF #1 and LCF #3. FIG. 6A shows CV curves for LCF #1 at scan rates of 1 mV s⁻¹-20 mV s⁻¹. FIG. 6B shows constant-current charge/discharge curves for LCF #1 at current densities 1 mA cm⁻²-20 mA cm⁻². FIG. 6C shows a Nyquist plot for LCF #1 (inset of high frequency region not shown). FIG. 6D shows CV curves for LCF #3 at scan rates of 1 mV s⁻¹-20 mV s⁻¹. FIG. 6E shows constant-current charge/discharge curves for LCF #3 at current densities of 1 mA cm⁻²-20 mA cm⁻²2. FIG. 6F shows a Nyquist plot for LCF #3 (inset of high frequency region not shown). FIG. 6G shows the gravimetric capacitance for LCF #3 at 0.5 A g⁻¹. FIG. 6H shows capacitance of LCF #3 at different current densities. FIG. 6I shows cyclic performance of LCF #3 at 100 mV s⁻¹ for 5,000 cycles.

FIGS. 7A-7D: Zeta potential measurements. FIG. 7A shows the particle size distribution and FIG. 7B shows the zeta potential of LCF #1. FIG. 7C shows the particle size distribution and FIG. 7D shows the zeta potential of LCF #3. In these figures, the particles refer to colloidal sodium ions surrounded by solvent molecules (generally water).

FIGS. 8A-8F: Kinetics of charge storage mechanism and quantitative analysis of capacitive (inner region) and diffusion (outer region) capacities of LCF #3 at various scan rates: (FIG. 8A) 1 mV s⁻¹, (FIG. 8B) 2 mV s⁻¹, (FIG. 8C) 5 mV s⁻¹, (FIG. 8D) 10 mV s⁻¹, and (FIG. 8E) 20 mV s⁻¹. FIG. 8F shows normalized contribution ratio of capacitive (lower portion) and diffusion-controlled (upper portion) capacities at various scan rates.

FIGS. 9A-9B compare LCF #3 to existing electrode materials. FIG. 9A shows areal capacitance (right bars and right axis) and thickness (left bars and left axis). FIG. 9B shows volumetric capacitance.

FIGS. 10A-1B show the results of thermogravimetric analysis of Na-carbon composite bodies having various amounts of Na therein (weight %), including a comparative carbon body made from unmetallized kraft lignin. FIG. 10A shows that Na metallization significantly reduces the amount of carbon lost from the Na-carbon composite bodies at temperatures greater than about 400° C. FIG. 10B shows that Na metallization reduces the thermal decomposition temperature of the Na-carbon composite bodies.

FIGS. 11A-11B show SEM images of a Na-carbon composite body that was cut to reveal the inner surfaces of the body. FIG. 11A is the SEM image from the freshly cut sample while FIG. 11B is the SEM image after the sample had been exposed to air after 24 hours. Exposure to air allows any accessible Na within pores and defects of the sample to react with O₂, CO₂, and H₂O (all from air) to form compounds such as sodium oxide, sodium hydroxide, sodium carbonate. FIG. 11B shows the growth of crystals from such pores and defects in the sample, confirming the presence of Na therein which results in the growth of nanocrystals of sodium oxide, sodium hydroxide, sodium carbonate. Such images illustrate that the metallization methods described herein achieve a three-dimensional (3D) metallic (here, sodium) network intertwined within a 3D carbon network.

### DETAILED DESCRIPTION

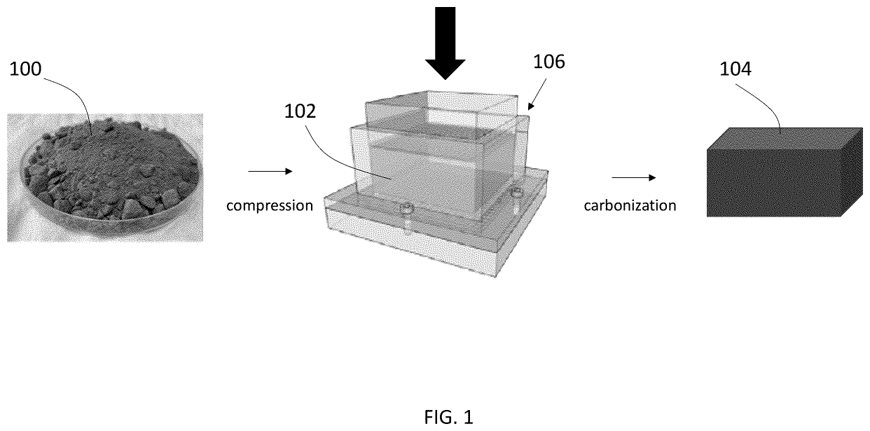

Provided are methods of forming metal-carbon composite bodies. The methods comprise compressing a metallized biomass to form a compressed metallized biomass body, followed by carbonizing the compressed metallized biomass body to form the metal-carbon composite body. The methods may further comprise forming the metallized biomass. Steps of the present methods are shown in FIG. 1, according to an illustrative embodiment, including compressing a metallized biomass 100 (which is in the form of a powder) to form a compressed metallized biomass body 102, and carbonizing the compressed metallized biomass body 102 to form a metal-carbon composite body 104 (which is in the form of a solid, unitary, monolithic, free-standing, 3D structure).

### Metallized Biomass

The metallized biomass comprises (or consists of) biomass which has been subjected to conditions to induce the formation of metallized functional groups from biomass functional groups in the biomass. The term “biomass” as used in the present disclosure, refers to carbonaceous materials derived from a living organism, generally a plant. Thus, biomass encompasses lignin, cellulose, and hemicellulose. More generally, biomass also encompasses various grasses and woods in various forms (e.g., chips, powder, pulp, char, etc.) Biomass also encompasses the sugars, including polysaccharides, which are derived from grass/wood such as glucose, xylose, arabinose, galactose, mannose, etc.

The term “lignin” as used in the present disclosure encompasses lignin derived from various sources and/or obtained using various extraction processes. Thus, lignin encompasses kraft lignin, sulfate lignin, lignosulfonates, milled wood lignin, organosolv lignin, alkali lignin, soda lignin, hydrolytic lignin, and klason lignin. Kraft lignin may be recovered from black liquor, the waste product from the kraft process. Lignosulfonate may be recovered from red or brown liquor from the sulfite pulping process. Thus, biomass also encompasses these sources of lignin, i.e., these various liquors.

In embodiments, the biomass comprises or consists of lignin. In embodiments, the biomass comprises or consists of kraft lignin.

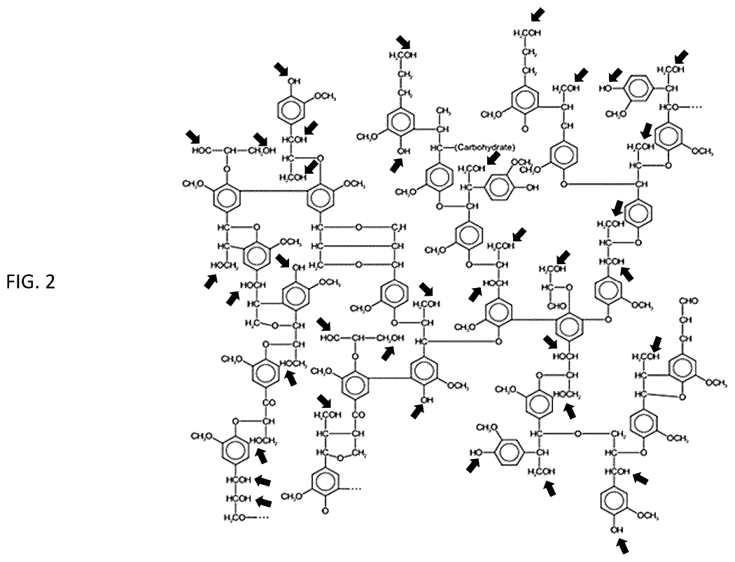

Lignin (as well as other types of the biomass referenced above) may be characterized as being a biopolymer comprising a hydrocarbon backbone and a plurality of biomass functional groups distributed along the hydrocarbon backbone and covalently bound thereto. Thus, the biomass being used in the present methods is generally molecular in nature, e.g., a collection of individual biopolymer molecules. The chemical constitution of the hydrocarbon backbone depends upon the particular biomass being used. However, by way of example, lignin's hydrocarbon backbone is formed from various phenolic monomers including 4-hydroxy-3-methoxyphenylpropane, 3,5-dimethoxy-4-hydroxyphenylpropane, and 4-hydroxyphenylpropane. Similarly, the type(s) and relative amounts of the biomass functional groups depend upon the particular biomass being used. However, biomass functional groups may include, e.g., hydroxyl groups (—OH), carboxylic acid groups (—COOH), thiol groups (—SH), amine groups (—NH₂), carbonyl groups (—C(O)) and combinations thereof. (In each of these groups, the “—” refers to the covalent bond between the biomass functional group and the hydrocarbon backbone.) Taking lignin as an example, the hydroxyl functional group is generally the most prevalent functional group in the biopolymer and may be present, e.g., in an amount of from 5 weight % to 15 weight %, from 7 weight % to 12 weight %, or from 8 weight % to 11 weight % (as compared to the total weight of the lignin). FIG. 2 shows the chemical structure of a portion of a softwood lignin, in which hydroxyl biomass functional groups are labeled with arrows. This chemical structure shows that the hydroxyl biomass functional groups are distributed uniformly throughout lignin.

The biomass may be characterized by its metal content prior to metallization. Although the metal content may vary depending upon the type of biomass, generally, the metal content prior to metallization is low. In embodiments, the metal content of the biomass is less than 2 weight %, less than 1 weight %, less than 0.5 weight %, or in a range of from 0 weight % to 1 weight % or from 0 weight % to 2 weight %. These amounts are by reference to the total weight of the biomass. The metal content may refer to any type of metal, including alkali metals, alkaline earth metals, and Group 13 elements.

Under appropriate conditions, each biomass functional group described above may be induced to form a bond (e.g., an ionic bond) to a metal cation, thereby converting the biomass functional groups to metallized functional groups. Taking a hydroxyl biomass functional group and a monovalent metal cation M⁺ as an example, the chemical reaction may be represented as: —OH+M⁺→—OM, wherein “—OM” represents the metallized hydroxyl group. As the metallized functional groups are derived directly from the biomass functional groups, the metallized functional groups are also distributed along the hydrocarbon backbone of the biomass and covalently bound thereto. Thus, inducing the formation of the metal cation bond(s) converts the starting biomass to metallized biomass. This may be envisioned by referring back to the hydroxyl groups of FIG. 2 in which each “H” is replaced by an “M.” It is noted that the metallization is not limited to the chemical reactions between hydroxyl groups and metal cations; other biomass functional groups may undergo analogous chemical reactions with metal cations under appropriate conditions, including those biomass functional groups listed above. Similarly, any biomass functional group that is capable of forming a bond to a metal cation under the selected conditions may be used.

The metal of the metal cations and the metallized functional groups may be selected from various types of metals. In embodiments, the metal is an alkali metal (e.g., Li, Na, K, Rb, Cs). In embodiments, the metal is Na. In embodiments, the metal is an alkaline earth metal (e.g., Be, Mg, Ca, Sr). In embodiments, the metal is a Group 13 element (e.g., B, Al). In embodiments, the metal is not a transition metal and the metallized biomass (and the resulting metal-carbon composite body) is free of transition metals. A single type of metal or multiple, different types of metals may be used.

The description above demonstrates how the biomass of the present disclosure is distinguished from other carbonaceous materials such as graphite, graphene, graphene oxide, activated carbon, carbon black, carbon foams, diamond-like carbon, carbon nanotubes, carbon fibers, carbon nanofibers, and the like. These other carbonaceous materials may be distinguished from the present biomass by comprising different (and/or different amounts thereof) chemical structures/functionalities (e.g., not having the biomass functional groups and/or at different amounts) and/or having a different morphology as compared to the present biomass (e.g., not being in the form of a collection of individual biopolymer molecules).

Prior to metallization, the biomass may be characterized by its moisture content. Moisture content may be determined using the ASTM D4442-07 standard. The moisture content of the biomass may be in a range of from 0 weight % to 30 weight % (as compared to the total weight of the water and the biomass). This includes moisture contents of no more than 20 weight %, no more than 15 weight %, no more than 10 weight %, no more than 5 weight %, no more than 3 weight %, no more than 2 weight %, or no more than 1 weight %. As further described below, reducing moisture content is useful to suppress pore formation during carbonization. This includes suppressing formation of pores of a certain size, including the relatively large pores (e.g., greater than 200 mm) described below. The biomass may be dried in order to reduce its moisture content prior to metallization, including to achieve any of the moisture content values described in this paragraph. Drying may be carried out by heating to a temperature (greater than room temperature (20° C. to 25° C.)) for a period of time (e.g., in a range of from 5 hours to 24 hours, or from 10 hours to 15 hours). However, the temperature is less than a temperature that induces decomposition of the biomass. This includes a temperature of less than 250° C., less than 200° C., including from 50° C. to 150° C. and from 75° C. to 125° C.

The metallization of the biomass may be accomplished by combining the biomass with a source of metal cations under conditions to induce the reactions between biomass functional groups and metal cations described above. The source of the metal cations is generally a metal compound that is capable of providing the metal cations under these conditions. Generally, the metal compound is an ionic compound in which the metal is bound to a counter anion(s) via ionic bonding. Suitable metal compounds include, e.g., metal hydroxides, metal halides, metal nitrates, metal sulfides, metal sulfites, metal carbonates, etc. The metal compound may be selected, at least in part, on the basis of its ability to facilitate denaturization of the selected biomass. The term “denaturation” refers to the relaxation of the tertiary structure of the biopolymer of the biomass, e.g., relaxation from a globule to an extended chain. This can involve breaking of relatively weak links (e.g., hydrogen bonds) within the biopolymer. This can involve ionization of biomass functional groups, e.g., —OH to —O—, within the biopolymer. By way of illustration, metal hydroxides are particularly suitable for use with certain biomass such as lignin as the metal hydroxide provides both the source of the metal cations and facilitates denaturization of lignin. This, in turn, facilitates the metallization of lignin's biomass functional groups as described above. Different metal compounds may be used so as to provide different types of metal cations in the metallized biomass, or a single type of metal compound may be used to as to provide a single type of metal cation.

The “conditions” under which biomass metallization is carried out may refer to parameters, e.g., mixing technique, mixing speeds, mixing times, mixing temperatures, etc., under which the combining is carried out. The conditions may also refer to the use of a liquid medium in which the biomass and the metal compound are dispersed during combining. The liquid medium may be selected to facilitate solubilization and thus, denaturation of the selected biomass. The liquid medium may comprise (or consist of) water, one or more organic solvents (e.g., tetrahydrofuran, dimethylsulfoxide, etc.), or combinations thereof. In embodiments, a liquid medium is used which comprises or consists of water. The conditions may also refer to the relative amounts of the biomass and the metal cation source being used. All conditions are generally selected to facilitate biomass metallization, including to achieve maximum conversion (including complete conversion) of biomass functional groups to metallized functional groups. Illustrative conditions are provided in the Examples, below. (See Examples 1-24 below.)

The metallized biomass may be dried prior to use, e.g., prior to the compression and carbonization steps described below, so as to remove any solvent(s) and/or to reduce moisture content, including to any of the moisture content values described above with respect to the biomass prior to metallization. Drying may be carried out as described above with respect to the biomass prior to metallization. In embodiments, the moisture content of the metallized biomass is no more than 10 weight %, no more than 5 weight %, or in a range of from 0 weight % to 10 weight % or from 0 weight % to 5 weight % (as compared to the total weight of the water and the metallized biomass).

The metallized biomass is generally in the form of a powder composed of a plurality of discrete particles, e.g., having a size of from about 50 mm to 500 mm, from 75 mm to 250 mm, or from 100 mm to 200 mm. Blending, crushing, ball milling, etc., may be used to achieve these particle sizes. The individual particles of the metallized biomass generally do not cohere together (nor are they fused) and thus, the powder may be characterized using terms such as “loose,” “free flowing,” and the like. This is demonstrated in the metallized biomass 100 of FIG. 1.

### Compression

As noted above, the present methods comprise compressing the metallized biomass. Any of the metallized biomass compositions described above and herein may be used. The compression step comprises subjecting the metallized biomass to pressure for a period of time. The pressure may be at least 100 psi, at least 1000 psi, at least 5,000 psi, at least 10,000 psi, or in a range of from 100 psi to 50,000 psi, from 100 psi to 25,000 psi, from 500 psi to 20,000 psi, or from 750 psi to 15,000 psi. The period of time may be at least 5 sec, at least 25 sec, at least 1 min, or in a range of from 1 sec to 1 hour, from 10 sec to 30 min, or from 15 sec to 1 min. The pressure may be a mechanical pressure. The compression step is generally carried out at room temperature, i.e., without application of any heating. The compression step may be carried out under an ambient atmosphere (i.e., in air) or under an inert atmosphere (e.g., under an inert gas such as Ar).

The compression step may be carried out using any type of molding assembly configured to contain a desired amount of the metallized biomass within a container of the molding assembly. The shape and dimensions of the container are not particularly limited but rather depend upon the amount of the metallized biomass to be used and the desired morphology (shape, dimensions) for the metal-carbon composite body. As shown in FIG. 1, the molding assembly 106 has a container having a rectangularly shaped internal cavity that provides the metal-carbon composite body 104 in the form of a rectangular block. The vertical arrow in FIG. 1 illustrates the application of mechanical pressure to achieve compression, but the arrow is not intended to limit the application of pressure to any particular direction or technique.

The metallized biomass may be provided as part of a precursor composition that may comprise one or more types of an additive. However, in other embodiments, the metallized biomass is provided alone with no other additives. When additives are used, these may include various synthetic polymers (polyacrylonitrile (PAN), polyethylene terephthalate (PET), polybenzimidazole (PBI), polystyrene (PS), polypropylene (PP), polyethylene (PE), etc.), unmetallized biomass (e.g., unmetallized lignin, unmetallized cellulose, etc.), or combinations thereof. By “unmetallized” it is meant that the biomass has not been subjected to the disclosed metallization process. The metal content of the unmetallized biomass may be within the ranges described above with respect to the biomass prior to metallization (e.g., from 0 weight % to 2 weight % or from 0 weight % to 1 weight %). A single type of additive or multiple, different types of additives may be used.

When additives are used, various relative amounts of the metallized biomass and the additive(s) may be used. In embodiments, the precursor composition comprises at least 60 weight % of the metallized biomass. This includes at least 70 weight %, at least 80 weight %, at least 90 weight %, and from 75 weight % to 99 weight %, from 80 weight % to 98 weight %, and from 85 weight % to 95 weight %. In embodiments, the precursor composition comprises no more than 40 weight % of an additive. This includes no more than 30 weight %, no more than 20 weight %, no more than 10 weight %, and from 1 weight % to 25 weight %, from 2 weight % to 20 weight %, and from 5 weight % to 15 weight %. If different types of metallized biomass/additives are used, these amounts may refer to the total amounts of each. All weight % values are all as compared to the total weight of the precursor composition.

In embodiments, the precursor composition comprises or consists of the metallized biomass and an additive. The additive may be selected from synthetic polymers, unmetallized biomass, or combinations thereof. The unmetallized biomass may be unmetallized lignin, e.g., unmetallized kraft lignin.

Prior to compression, the precursor composition may itself be characterized by a moisture content, which may be any of the moisture content values described above with respect to the metallized biomass. Drying may be carried out prior to compression, as described above with respect to the metallized biomass.

The result of the compression step is a compressed metallized biomass body. (The phrase “compressed precursor composition body” may be used if the metallized biomass is provided along with additive(s) as described above.) The chemical constitution of the compressed metallized biomass body is generally similar to that of the uncompressed metallized biomass, e.g., comprising metallized biopolymers comprising hydrocarbon backbones and a plurality of metallized functional groups distributed along and covalently bound thereto. However, the morphology of the compressed metallized biomass body is different. Unlike the uncompressed metallized biomass (which is a powder), after compression, particles of the metallized biomass cohere, and may even fuse, together such that the compressed metallized biomass is a solid, unitary, monolithic, free-standing, three-dimensional (3D) structure. Use of the term “body” is intended to connote these characteristics and is distinguished from powders. The size and shape of this structure/body (generally dictated by the molding assembly/desired application) are not particularly limited.

As demonstrated in the Examples, below, use of the present compression step has been found to significantly increase the amount of metal retained within the subsequently formed metal-carbon composite bodies, e.g., by over 4 times, as compared to using uncompressed metallized biomass. (See Example 19 (Na—C—O-5) and Comparative Example 20 (Na—C—O-NoPress1), Table 2.) This is surprising since carbonization involves conditions that promote metal diffusion and evaporation (i.e., relatively high temperatures and relatively low pressures), both of which would be expected to largely prevent retention of metal within the carbonized material.

### Carbonization

As noted above, the present methods further comprise carbonizing the compressed metallized biomass body to form the metal-carbon composite body. (The phrase “compressed precursor composition body” may be used if the metallized biomass is provided along with additive(s) as described above.) The carbonization step comprises heating the compressed metallized biomass body according to a heating profile, which refers to the temperature being used as a function of time. In general, the heating is applied to increase the temperature of the compressed metallized biomass from an initial temperature (e.g., room temperature) to a maximum temperature at a heating rate. However, various maximum temperatures and heating rates may be used as desired. In addition, the heating may involve one or more isothermal holds at certain temperatures and/or the use of one or more heating rates over the course of the heating. The maximum temperature is generally less than 1200° C. and may be in the range of from 750° C. to 1200° C., from 800° C. to 1200° C., or from 900° C. to 1200° C. Heating rates may be used which are in the range of from 0.1° C./min to 10° C./min, 1° C./min to 10° C./min, or 0.5° C./min to 5° C./min. The overall heating time depends upon any isothermal holds and heating rate(s) being used, but is generally in a range of 1 to 8 hours, 1 to 6 hours, or 1 to 3 hours. Illustrative heating profiles are provided in the Examples, below. (See Examples 19-46.)

The carbonization step is generally carried out under an inert, non-oxidizing atmosphere (e.g., under an inert gas such as Ar), although a source of gaseous hydrocarbons may be supplied during carbonization as further described below. The carbonization step is generally carried out without applying mechanical pressure (by contrast to the compression step). The carbonization step may be carried out under vacuum conditions or under atmospheric pressure. If an inert, non-oxidizing atmosphere is used, the gas pressure may range from atmospheric pressure to 15 psig.

As noted above, the carbonization step may comprise supplying a source of gaseous hydrocarbons during the heating of the compressed metallized biomass body. Hydrocarbons having relatively few numbers of carbon atoms may be used, e.g., carbon atoms in a range of from 1 to 6, 1 to 4, or 1 to 3. The hydrocarbons may be alkanes, alkenes, or alkynes. The hydrocarbons may be linear in form. The hydrocarbons are generally unsubstituted, i.e., they contain only carbon and hydrogen atoms. Illustrative hydrocarbons include methane, ethane, ethylene, ethyne, propane, propene, propylene. The source of the gaseous hydrocarbons may be a hydrocarbon gas supplied during the heating of the compressed metallized biomass body. The hydrocarbon gas may be supplied alone or along with an inert carrier gas. The source may be supplied at an intermediate temperature (or range) between the initial temperature and the maximum temperature being used in the heating. The intermediate temperature (or range), pressure/flow rate at which the source is supplied, and length of time the source is supplied may be adjusted as desired. Illustrative values of these parameters are provided in the Examples below. (See Examples 21, 23, 27, 29.)

The carbonization step induces various chemical reactions to take place within the compressed metallized biomass body to form the metal-carbon composite body. These include chemical reactions that result in the elimination of non-carbon elements present therein, e.g., oxygen, hydrogen, nitrogen, sulfur. These non-carbon elements may be eliminated from the compressed metallized biomass body in the form of products such as H₂O, CO₂, CO, CH₄, light hydrocarbons, organic volatiles, tar, etc. However, some non-carbon elements may be left behind after carbonization, including, e.g., oxygen, sulfur. Nevertheless, the primary component that is left behind after carbonization is carbon, the atoms of which are generally covalently bound to one another, forming a continuous carbon matrix extending throughout the 3D space defined by the outer surfaces of the metal-carbon composite body. Thus, the carbon matrix itself may be described as a 3D network. The carbon of this carbon matrix includes sp³ hybridized carbon (hard carbon). The carbon may also include sp² hybridized carbon (soft carbon), although the amount of sp³ hybridized carbon is generally greater than the amount of sp² hybridized carbon. In embodiments, the ratio of sp³:sp² hybridized carbon is in a range of from 50:1 to 20:1, 40:1 to 20:1, 30:1 to 5:1, from 25:1 to 5:1, from 20:1 to 5:1, and from 10:1 to 5:1. X-ray diffraction (XRD) and Raman measurements may be used to determine such ratios.

Also during carbonization, metal ions from the metallized functional groups in the metallized biomass are reduced to metal atoms. The phrase “metal atoms” and the like refers to metal having an oxidation state of about zero. The molecular level metallization achieved by converting individual biomass functional groups to metallized functional groups means that these metal atoms end up being uniformly distributed throughout the carbon matrix. However, depending upon the type of metal and the carbonization conditions being used, metal atoms may diffuse within the carbon matrix during carbonization. It is believed that this diffusion contributes to the formation of pores within and distributed throughout the carbon matrix. Some such pores may be in the form of elongated tortuous channels having an average cross-sectional diameter of no more than 1 μm, no more than 500 nm, no more than 250 nm, no more than 100 nm, or in a range of from 0.1 nm to 1 μm, from 0.1 to 500 nm, from 0.1 nm to 250 nm, from 0.1 nm to 200 nm, from 0.1 nm to 100 nm, or from 0.1 nm to 10 nm. Thus, the pore diameters are relatively small. Other such pores may be generally spherical in form having an average cross-sectional diameter within any of these ranges.

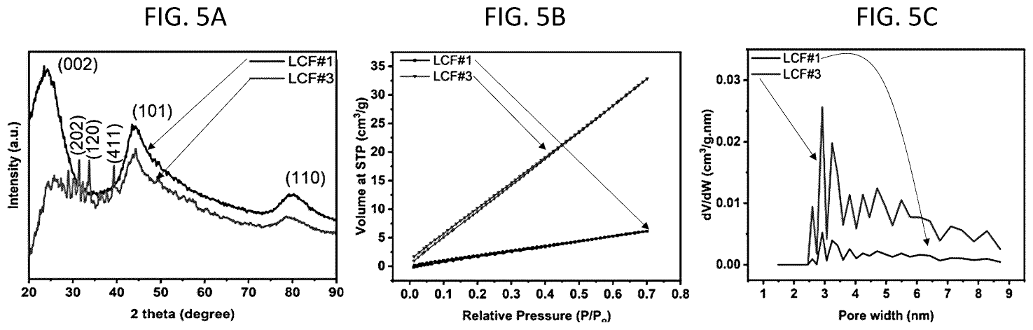

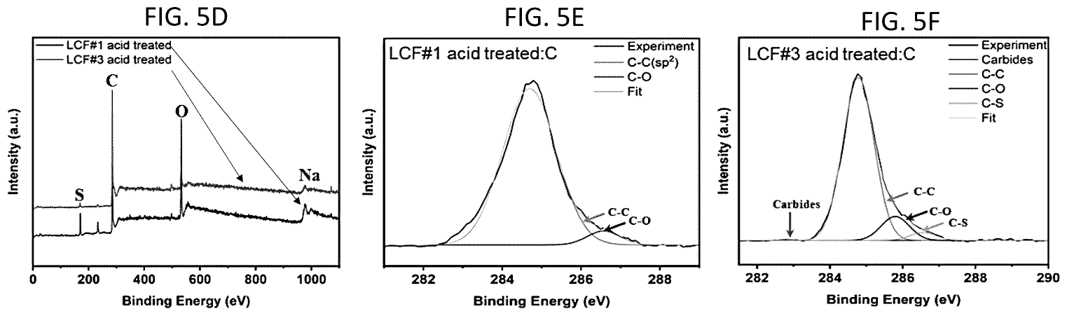

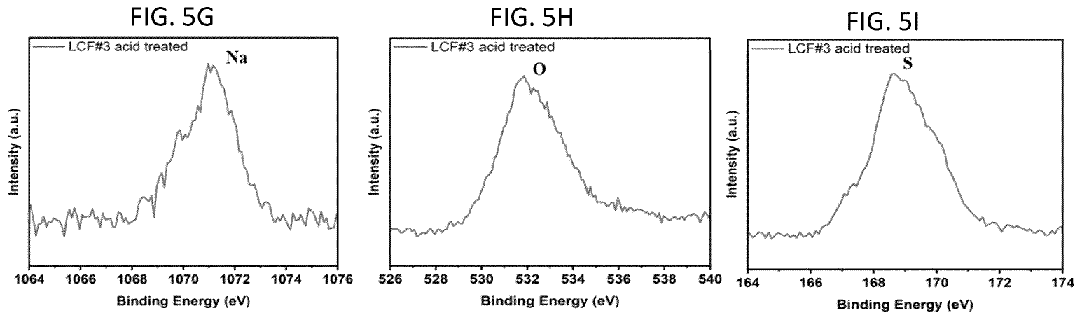

Notably, the present metal-carbon composite bodies have a greater percentage of small pores (e.g., having pore diameters within any of the ranges disclosed above, including from 0.1 nm to 10 nm) as compared to comparative composite bodies formed from unmetallized biomass (see FIG. 5C). Similarly, at least in embodiments, a majority (e.g., greater than 60%, greater than 70%, greater than 80%, or greater than 90%) of the pores of the metal-carbon composite bodies are small pores (e.g., having pore diameters within any of the ranges disclosed above, including from 0.1 nm to 10 nm). This large percentage of small pores is believed to be due to the particular metallization methods disclosed herein.

It is noted that any pores of the present metal-carbon composite bodies are not necessarily voids therein as they may be partially filled, or fully filled, with metal atoms. Metal atoms may also occupy any defects present in the carbon matrix such as cracks, channels, fissures therein, each of which may have a largest cross-sectional dimension within the ranges of the pore sizes described above. Some of the sp² hybridized carbon of the carbon matrix may be in the form of stacks of graphene layers and metal atoms may also be present between individual graphene layers in the stacks. Scanning electron microscopy (SEM) and/or energy dispersive X-ray (SEM/EDX) may be used to evaluate the distribution and location of the metal atoms.

The uniform distribution of metal atoms throughout the carbon matrix, including within pores, defects, and/or graphene layers of this matrix as described above, results in a 3D metallic network comprising (or consisting of) the metal atoms that is intertwined with the 3D carbon network at the atomic level. However, unlike the carbon of the 3D carbon network (which is generally covalently bound together to form the continuous matrix), the metal atoms of the 3D metallic network are not necessarily bound to one another. Some coalescence of metal atoms generally occurs, but isolated metal atoms may also be present. It is believed that this intimate interconnectivity between the carbon and the metal at the atomic level provides the metal-carbon composite bodies with superior properties as compared to existing metal-carbon composites, including those further described below.

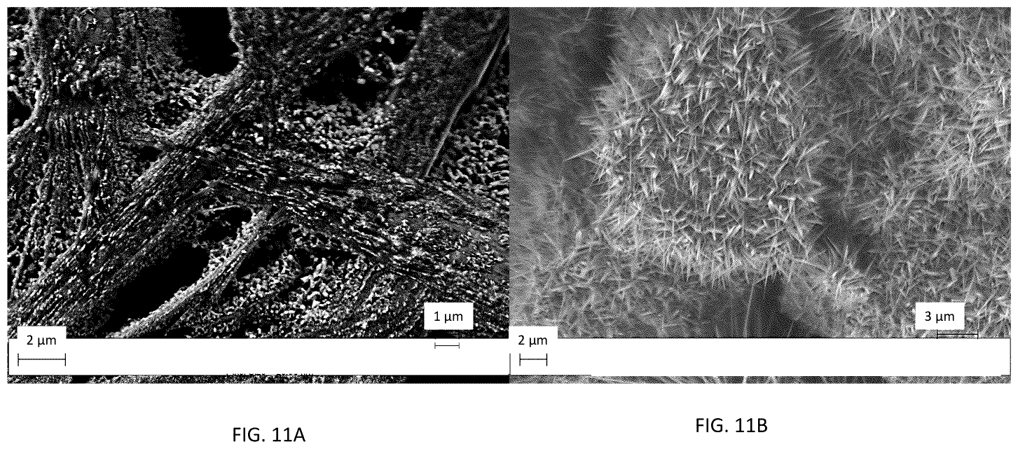

Evidence of the uniform distribution of metal atoms, presence of metal atoms within pores and defects, and formation of the 3D metallic network intertwined with the 3D carbon network is provided by SEM images similar to those shown in FIGS. 11A-11B. These figures show SEM images of a Na-carbon composite body that was cut to reveal the inner surfaces of the body. FIG. 11A is the SEM image from the freshly cut sample while FIG. 11B is the SEM image after the sample had been exposed to air after 24 hours. Exposure to air allows any accessible Na within pores and defects of the sample to react with O₂, CO₂, and H₂O (all from air) to form compounds such as sodium oxide, sodium hydroxide, sodium carbonate. FIG. 11B shows the growth of crystals from such pores and defects in the sample, confirming the presence of Na therein which results in the growth of a 3D network of nanocrystals of sodium oxide, sodium hydroxide, sodium carbonate.

It is believed that carbon atoms of the carbon matrix that are in contact with, or closest to, the metal atoms may be bound as sp² hybridized carbon. As a result, the sp² hybridized carbon in the present metal-carbon composite bodies may be localized to the surfaces of the carbon matrix that define the metal-containing pores described above. High resolution SEM and transmission electron microscopy (TEM) may be used to identify the location of the sp² hybridized carbon.

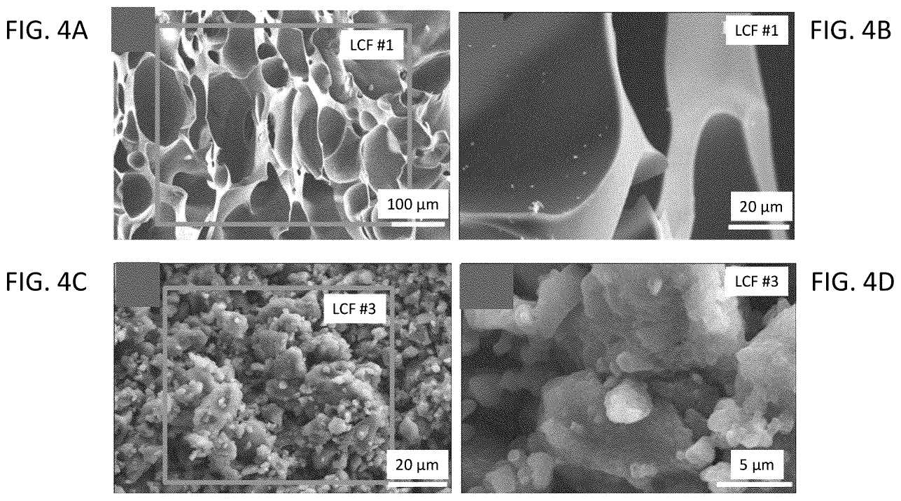

Although other pores may be formed in the present metal-carbon composite bodies during carbonization (i.e., other than those formed by diffusing metal atoms), generally, relatively large pores are not formed, e.g., pores having cross-sectional diameters greater than 200 mm, greater than 250 mm, or in a range of from 200 mm to 500 mm. It is believed that these relatively large pores generally do not form during carbonization since biomass functional groups that could generate vaporized water during carbonization (e.g., hydroxyl biomass functional groups) are not significantly present in the compressed metallized biomass (as they have been converted to metallized functional groups). In addition, as noted above, the compressed metallized biomass is generally characterized by relatively low moisture contents, further reducing any source of vaporized water, and thus, suppressing the formation of large pores. By contrast, as shown in FIGS. 4A-4B, comparative carbon bodies formed from unmetallized biomass are characterized by the presence of relatively large pores.

As noted above, a source of gaseous hydrocarbons may be supplied during carbonization to form the metal-carbon composite body. In such embodiments, additional chemical reactions may take place which result in the deposition of additional carbon on and/or within the compressed metallized biomass body. This additional carbon (including together with the metal atoms as described above) can partially fill, or fully fill, open pores (voids) within the carbon matrix. This additional carbon can coat external surfaces of the metal-carbon composite body. As further described below, this carbon deposition can result in the metal-carbon composite body having a substantially reduced specific surface area (SSA) as compared to embodiments which do not make use of an added source of gaseous hydrocarbons. Metal-carbon composite bodies formed using an added source of gaseous hydrocarbons may be referred to in the Examples below and throughout the present disclosure as “sealed” (“S”) metal-carbon composite bodies. Use of an added source of gaseous hydrocarbons also further increases the amount of metal retained within the metal-carbon composite bodies. (See Example 19 (Na—C—O-5) and Example 21 (Na—C—S-5), Table 2.) As further described below, metal-carbon composite bodies formed without using an added source of gaseous hydrocarbons during carbonization generally have substantially higher SSA values and may be referred to as “open” (“O”) metal-carbon composite bodies.

Pore shapes, sizes, and SSA values for the metal-carbon composite bodies may be determined by using nitrogen adsorption over a surface area analyzer (e.g., Tristar II, Micromeritics, USA).

As noted throughout the description above, the result of the carbonization step is a metal-carbon composite body. The chemical constitution and physical characteristics of the metal-carbon composite body have been described above and will be further described below. Like the compressed metallized biomass body, the metal-carbon composite body is also a solid, unitary, monolithic, free-standing, 3D structure. The size and shape of this structure/body (dictated by the compressed metallized biomass) is not particularly limited.

### Metal Conversion Treatment

The present methods may further comprise converting the metal of the metal-carbon composite body from atomic metal to another chemical form, e.g., a metal-containing compound. Conversion to a metal-containing compound may be accomplished by exposing the metal-carbon composite body to a reactant under conditions to induce a reaction between the metal and reactant to form the metal-containing compound. The particular metal-containing compound formed depends upon the type of metal, the type of reactant, and the conditions being used. Illustrative reactants and corresponding metal-containing compounds include: H₂ to form a metal hydride; water or a hydroxide to form a metal hydroxide; CO₂ or a carbonate to form a metal carbonate; O₂ or air to from a metal oxide; N₂ or nitrogen to form a metal nitride or a metal amide; H₂S to form a metal sulfide; phosphorus to form a metal phosphide; a halide to form a metal halide. A single type of reactant or multiple, different types of reactants may be used (e.g., both H₂ and NH₃ may be used to form a metal amide). Sulfuric acid and hydrogen peroxide are other illustrative reactants that may be used.

Various techniques may be used to carry out exposure of the metal-carbon composite body to the reactant. For gaseous reactants, the metal-carbon composite body may be exposed to an atmosphere containing the gaseous reactant. Parameters such as the temperature (or range) at which exposure occurs, reactant flow rate/pressure during exposure, and length of time of exposure may be adjusted to as desired, including to achieve maximum (including complete) conversion of the metal atoms to the metal-containing compound. Illustrative values of these parameters are provided in the Examples below. (See Examples 24-42 and 44-46.) For reactants in their liquid form or in a liquid medium, exposure may be accomplished by soaking, immersing, dipping, etc., the metal-carbon composite body therein. Again, parameters such as temperature (or range), reactant concentration, length of time may be similarly adjusted. (See Example 43.)

If used, the metal conversion treatment may take place after the carbonization step. However, in embodiments, the metal conversion may take place during the carbonization step, e.g., at an intermediate time during heating of the compressed metallized biomass body. (See Examples 41, 42.)

If the metal conversion treatment is used, the resulting metal-carbon composite body may be characterized as described in “Carbonization” above except that “metal atoms” is replaced with “metal-containing compound.”

### Metal-Carbon Composite Bodies

The metal-carbon composite bodies formed using the present methods are also encompassed by the present disclosure. The chemical constitution and physical characteristics of the metal-carbon composite bodies have been described above and are now further described below. More generally, however, the material of the metal-carbon composite bodies may be described with reference to its morphology at various scales. For example, at the atomic scale (or nanoscale) (referring to features on the order of, e.g., about 0.1 nm to about 100 nm) the morphology of the metal-carbon composite bodies is that of a continuous, covalently bound carbon matrix extending in three dimensions (i.e., the 3D carbon network) with metal distributed throughout the matrix. As noted above, the metal itself may be characterized as being in the form of a 3D metallic network intertwined with the 3D carbon network. Thus, at the atomic scale (or nanoscale), the material of the metal-carbon composite bodies may be described as a 3D carbon network intertwined with a 3D metallic network. At the macroscale (referring to features on the order of, e.g., greater than about 1 mm), the morphology of the metal-carbon composite body is that of a solid, unitary, monolithic, free-standing, three-dimensional structure (see block 104 in FIG. 1).

The carbon matrix of the metal-carbon composite bodies may be characterized by its sp³ hybridized carbon content, its sp² hybridized carbon content, and its sp³:sp² ratio as described above.

For metal-carbon composite bodies formed without using the metal conversion treatment described above, the metal is present in its atomic form. For metal-carbon composite bodies formed using the metal conversion treatment described above, the metal is present in a molecular form (i.e., a metal-containing compound). In any of the embodiments, the metal may be located within pores defined by the carbon matrix, defects defined by the carbon matrix, and/or between graphene layers of the carbon matrix. The metal may be present in the form of isolated metal atoms (or isolated metal-containing compounds). However, due to metal diffusion, metal may coalesce as noted above. However, the average cross-sectional dimension of coalesced metal is generally not larger than that of the pores, defects, graphene interlayers described herein. Regions of the carbon matrix in contact with the metal and/or defining the pores may sp² hybridized.

The metal-carbon composite bodies may be characterized by the amount of metal therein (whether the metal is in its atomic form or molecular form,). The amount may be greater than 1 weight %, at least 5 weight %, at least 8 weight %, at least 10 weight %, at least 11 weight %, at least 13 weight %, at least 15 weight %, at least 18 weight %, at least 20 weight %, at least 25 weight %, or at least 30 weight %. This includes amounts in a range of from 5 weight % to 30 weight %, from 10 weight % to 30 weight %, from 15 weight % to 30 weight % and from 15 weight % to 20 weight %. These amounts are by reference to the total weight of the metal-carbon composite body. The metal amounts may be determined using inductively coupled plasma mass spectrometry (ICP-MS). As described in the Examples, below, EDS mapping may also be used to determine metal amounts. As noted above, it is surprising that such high amounts of metal can be achieved since the carbonization process involves temperatures generally high enough to vaporize the metal, which would be expected to prevent retention of metal within the carbonized material. For metal-carbon composite bodies formed without using the metal conversion treatment described above, the balance weight % is generally carbon; the amount of non-carbon elements (generally oxygen and hydrogen) is generally less than 0.5 weight %; the amount of non-carbon, non-oxygen, non-hydrogen elements is generally less than 0.01 weight %. These amounts are by reference to the total weight of the metal-carbon composite body. The amounts of non-metal elements may be determined using a PE 2400 CHNS Elemental Analyzer (PerkinElmer, Waltham, MA, USA). EDS mapping may also be used.

By way of illustration, a comparative carbon body formed from unmetallized kraft lignin may be characterized as having a composition as follows: 98.5±0.5 weight % C, 0.5±0.2 weight % H, 0.0 weight % N and 0.01±0.01 weight % S. By “comparative” it is meant unmetallized kraft lignin subjected to the same compression and carbonization steps disclosed herein. As noted above, use of metallized kraft lignin in place of the unmetallized kraft lignin achieves unexpectedly high metal amounts, e.g., at least 10 weight % or from 15 weight % to 20 weight %

In another embodiment, Na-carbon composite bodies formed using a metal conversion treatment involving exposure to acid, peroxide, and air have the compositions shown in Table 5 below (LCF #2-4). Thus, the metal-carbon composite body may comprise or consist of, e.g., from 20 weight % to 75 weight % carbon, from 25 weight % to 15 weight % oxygen, from 5 weight % to 30 weight % metal (e.g., Na), from 0.5 weight % to 10 weight % sulfur, and hydrogen. Here, “consists of” does not preclude trace amounts of other elements, but if present, the trace amounts are less than 0.01 weight %.

In embodiments, the metal-carbon composite body consists of the carbon, the metal, and one or more of oxygen, sulfur, and hydrogen. Here, “consists of” does not preclude trace amounts of other elements, but if present, the trace amounts are less than 0.01 weight %. The metal may be selected from alkali metals, alkaline earth metals, Group 13 metals, and combinations thereof. The metal may be selected from Li, Na, K, Rb, Cs, Be, Mg, Ca, Sr, B, Al, and combinations thereof. The metal may be in its atomic form or its molecular form. In embodiments, the metal is in its atomic form. In embodiments, the metal is Na. In any of these embodiments, the amounts of the elements may be any of those disclosed above.

As noted above, the carbon matrix of the metal-carbon composite bodies may define a plurality of pores distributed throughout, although those pores are not necessary voids (due to the presence of metal). The pores may be characterized by an average cross-sectional diameter within any of the values described above. The carbon matrix may be characterized as having no pores greater than 200 mm, no pores greater than 250 mm, or no pores in a range of from 200 mm to 500 mm. By “no pores” it is meant that less than 5%, less than 2%, or less than 1% of any pores present have a cross-sectional diameter within these ranges.

The porosity of the metal-carbon composite bodies (which may be determined using nitrogen or carbon dioxide physisorption methods and after removing metal therefrom) may be at least 50%, at least 55%, at least 60%, at least 65%, at least 70%, or at least 75%.

The metal-carbon composite bodies may be characterized by a specific surface area (SSA). The SSA may be measured using BET (Brunauer-Emmett-Teller) analysis and a particular adsorbate under a particular temperature. Metal-carbon composite bodies formed without using an added source of gaseous hydrocarbons during carbonization generally have higher SSA values as compared to metal-carbon composite bodies using an added source of gaseous hydrocarbons during carbonization. If no added source of gaseous hydrocarbons is used, the metal-carbon composite body may be characterized by an SSA of at least 60 m²/g, at least 65 m²/g, at least 75 m²/g, at least 100 m²/g, at least 200 m²/g, at least 500 m²/g, at least 600 m²/g, at least 700 m²/g, or an SSA in a range of from 600 m²/g to 1000 m²/g. Such metal-carbon composite bodies may be referred to as “open (O) metal-carbon composite bodies.” If an added source of gaseous hydrocarbons is used, the metal-carbon composite body may be characterized by an SSA of no more than 50 m²/g, no more than 25 m²/g, no more than 15 m²/g, or an SSA in a range of from 0 m²/g to 50 m²/g. Such metal-carbon composite bodies may be referred to as “sealed (S) metal-carbon composite bodies.”

The metal-carbon composite body may be characterized by whether it is flammable or not flammable upon exposure to water or air at room temperature. The present open metal-carbon composite bodies may be flammable under such conditions while the present sealed metal-carbon composite bodies are generally not flammable under such conditions. This non-flammability may be true even though the metal-carbon composite body comprises a metal that would otherwise be flammable under such conditions.

### Applications for the Metal-Carbon Composites

After formation according to the present methods, any of the disclosed metal-carbon composite bodies may be used as is or may be machined (e.g., to alter the size/shape of the body) and/or combined with other material(s) for use as a desired article of manufacture or in a desired device. Such articles of manufacture and devices are also encompassed by the present disclosure.

By way of illustration, any of the present metal-carbon composite bodies may be used as an electrode material in an electrochemical device, e.g., a supercapacitor, a battery or a fuel cell. The battery may be a solid state or a liquid state battery. Unlike existing electrode materials, no binders (e.g., polymers such as polytetrafluoroethylene) or additives (e.g., conductive additives such as carbon black) are required. Thus, electrodes comprising any of the present metal-carbon composite bodies may be characterized as being free of a binder and free of an additive.

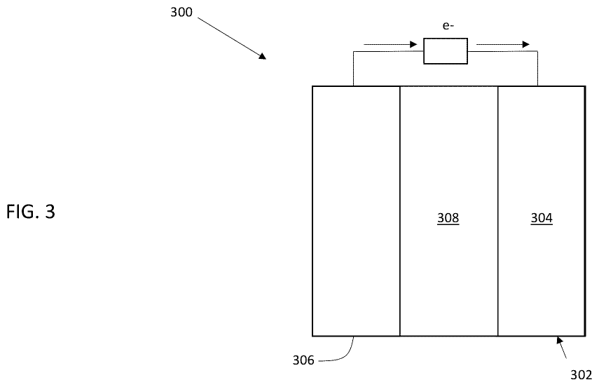

An illustrative electrochemical device 300 is shown in FIG. 3, comprising an electrode 302 comprising or consisting of any of the disclosed metal-carbon composite bodies 304, a counter electrode 306 in electrical communication with the electrode 302, and an electrolyte 308 between the electrode 302 and the counter electrode 306. The counter electrode 306 may also comprise or consist of any of the disclosed metal carbon composite bodies. The electrochemical device 300 may adopt any configuration and include any additional materials and/or components generally used with such devices. The electrochemical device 300 may be an alkali metal ion (e.g., Li, Na, etc.) battery. Any of the disclosed alkali metal (e.g., Li, Na, etc.)-carbon composite bodies are particularly suitable for use in the electrode(s) of such a battery. The electrochemical device 300 may be a direct formate fuel cell. Any of the disclosed Na-carbon composite bodies are particularly suitable for use in the electrode(s) of such a fuel cell. The electrochemical device 300 may be a hydrogen fuel cell. Any of the disclosed alkali metal hydride (e.g., NaH)-carbon composite bodies or alkali metal nitride-carbon composite bodies are particularly suitable for use in the electrode(s) of such a fuel cell.

As demonstrated in the Examples, below, supercapacitors comprising the present metal-carbon composite bodies as electrodes exhibit high areal capacitances (e.g., at least 19 F cm⁻² at a current density of 1 mA cm⁻² ) and volumetric capacitances (e.g., at least 7 F cm⁻³ at a current density of 1 mA cm⁻² ).

Other applications for the present metal-carbon composite bodies include any of those in which metal-carbon composites find use. These may include use of any of the disclosed metal-carbon composite bodies as a molecular sieve. These may include use of any of the disclosed metal-carbon composite bodies as a slow-releasing strong base or reducing reagent in organic synthesis reactions such as Dieckmann condensation, Stobbe condensation, Darzens condensation, Claisen condensation, dehydrohalogenation, cyclization reactions, Chichibabin reaction, etc.

Methods of using any of the disclosed metal-carbon composite bodies in any of the applications described above are also encompassed by the present disclosure.

### EXAMPLES

### Preparation of Metallized Biomass

### Na-Lignin Prepared With Different Loadings of Sodium (Example 1)

Kraft lignin (provided by Domtar with ˜30% moisture) used to prepare Na-lignin. The lignin was first crushed to fine powder (˜50-500 μm). Ten (10) NaOH solutions were prepared using different loadings of sodium hydroxide (NaOH): 8.87 g, 17.75 g, 26.62 g, 35.49 g, 44.37 g, 53.24 g, 62.11 g, 70.99 g, 79.86 g and 88.73 g. For each solution, the appropriate amount of NaOH was added to 500 mL deionized (DI) water in a 1000 mL glass beaker and stirred for 10 minutes. Each NaOH solution was added to 715 grams of kraft lignin powder held in a glass beaker (2000 mL) and mixed well to form a paste-like mixture. Each sample was dried in an oven at 100° C. overnight. The dried Na-lignin samples were crushed to a fine powder (˜50-500 μm) and labeled as P1-P10.

### Na-lignin prepared with kraft lignin pre-dried at different temperatures (Example 2)

Six (6) kraft lignin samples were dried in an oven at either 75° C., 100° C., 125° C., 150° C., or 175° C. overnight. Five hundred grams of each of pre-dried sample was mixed with 53.24 g NaOH and ball-milled at 1000 rpm for 30 minutes. The Na-lignin samples were labeled P11 (75° C. dried lignin), P12 (100° C. dried lignin), P13 (125° C. dried lignin), P14 (150° C. dried lignin), and P15 (175° C. dried lignin).

### Na-lignin prepared with different lignin sources (Example 3)

Four (4) samples were prepared using different lignin sources including alkali lignin, organsolv lignin, lignosulfonates, and hydrolyzed lignin. For each sample, 30 g NaOH was added to 500 mL DI water in a 1000 mL glass beaker and stirred for 10 minutes. Each NaOH solution was added to 500 grams of a respective lignin powder held in a 2000 mL glass beaker and mixed well to form a paste-like mixture. Each sample was dried in an oven at 100° C. overnight. The dried Na-lignin samples were crushed to a fine powder (˜50-500 μm) and labeled as P16-P19 and described in Table 1, below.

TABLE 1
Na-lignin using different lignin sources.

| Sample | Lignin Source |
|---|---|
| P16 | Alkali lignin |
| P17 | Organsolv lignin |
| P18 | Lignosulfonate lignin |
| P19 | Hydrolyzed lignin |

### Metallized Biomass Prepared With Different Types of Alkaline and Alkali Earth Metals (Examples 4-9)

### Example 4

Lithium lignin (Li-lignin) was prepared by mixing lignin powder and an aqueous solution of lithium hydroxide. 715 grams of kraft lignin (provided by Domtar, ˜30% moisture) was first added to a 2000 mL glass beaker. 35.21 grams of lithium hydroxide (LiOH) was added to 500 mL DI water in a 1000 mL glass beaker and stirred for 10 minutes. The LiOH solution was added to the lignin powder and mixed well to form a paste-like mixture. The Li-lignin sample was dried in an oven at 100° C. overnight. The dried Li-lignin sample was crushed to fine powder (˜50-500 μm) and labeled as P20.

### Example 5

Potassium lignin (K-lignin) was prepared by mixing lignin powder and an aqueous solution of potassium hydroxide. 715 grams of kraft lignin (provided by Domtar, ˜30% moisture) was first added to a 2000 mL glass beaker. 58.57 grams of potassium hydroxide (KOH) was added to 500 mL DI water in a 1000 mL glass beaker and stirred for 10 minutes. The KOH solution was added to the lignin powder and mixed well to form a paste-like mixture. The K-lignin sample was dried in an oven at 100° C. overnight. The dried K-lignin sample was crushed to fine powder (˜50-500 μm) and was labeled as P21.

### Example 6

Cesium lignin (Cs-lignin) was prepared by mixing lignin powder and an aqueous solution of cesium hydroxide. 715 grams of kraft lignin (provided by Domtar, ˜30% moisture) was first added to a 2000 mL glass beaker. 35.21 grams of cesium hydroxide was added to 500 mL DI water in a 1000 mL glass beaker and stirred for 10 minutes. The CsOH solution was added to the lignin powder and mixed well to form a paste-like mixture. The Cs-lignin sample was dried in an oven at 100° C. overnight. The dried Cs-lignin sample was crushed to fine powder (˜50-500 μm) and was labeled as P22.

### Example 7

Beryllium lignin (Be-lignin) was prepared by mixing lignin powder and an aqueous solution of beryllium chloride. 715 grams of kraft lignin (provided by Domtar, 30% moisture) was first added to a 2000 mL glass beaker. 90.61 grams of beryllium chloride (BeCl₂) was added to 500 mL DI water in a 1000 mL glass beaker and stirred for 10 minutes. The BeCl₂ solution was added to the lignin powder and mixed well to form a paste-like mixture. The Be-lignin sample was dried in an oven at 100° C. overnight. The dried Be-lignin sample was crushed to fine powder (˜50-500 μm) and was labeled as P23.

### Example 8

Magnesium lignin (Mg-lignin) was prepared by mixing lignin powder and an aqueous solution of magnesium chloride. 715 grams of kraft lignin (provided by Domtar, 30% moisture) was first added to a 2000 mL glass beaker. 99.95 grams of magnesium chloride (MgCl₂) was added to 500 mL DI water in a 1000 mL glass beaker and stirred for 10 minutes. The MgCl₂ solution was added to the lignin powder and mixed well to form a paste-like mixture. The Mg-lignin sample was dried in an oven at 100° C. overnight. The dried Mg-lignin sample was crushed to fine powder (˜50-500 μm) and was labeled as P24.

### Example 9

Calcium lignin (Ca-lignin) was prepared by mixing lignin powder and an aqueous solution of calcium chloride. 715 grams of kraft lignin (provided by Domtar, 30% moisture) was first added to a 2000 mL glass beaker. 35.21 grams of calcium chloride was added to 500 mL DI water in a 1000 mL glass beaker and stirred for 10 minutes. The CaCl₂ solution was added to the lignin powder and mixed well to form a paste-like mixture. The Ca-lignin sample was dried in an oven at 100° C. overnight. The dried Ca-lignin sample was crushed to fine powder (˜50-500 μm) and was labeled as P25.

### Preparation of B-Lignin and Al-Lignin (Examples 10-11)

### Example 10

Boron lignin (B-lignin) was prepared by mixing lignin powder and an aqueous solution of boric acid. 715 grams of kraft lignin (provided by Domtar, 30% moisture) was first added to a 2000 mL glass beaker. 115.66 grams of boric acid (B(OH)₃) was added to 500 mL DI water in a 1000 mL glass beaker and heated and stirred at 100° C. for 30 minutes. The B(OH)₃ solution was added to the lignin powder and mixed well to form a paste-like mixture. The B-lignin sample was dried in an oven at 100° C. overnight. The dried B-lignin sample was crushed to fine powder (˜50-500 μm) and was labeled as P26.

### Example 11

Aluminum lignin (Al-lignin) was prepared by mixing lignin powder and an aqueous solution of aluminum chloride. 715 grams of kraft lignin (provided by Domtar, 30% moisture) was first added to a 2000 mL glass beaker. 201.71 grams of aluminum chloride was added to 500 mL DI water in a 1000 mL glass beaker and stirred for 10 minutes. The AlCl₃ solution was added to the lignin powder and mixed well to form a paste-like mixture. The Al-lignin sample was dried in an oven at 100° C. overnight. The dried Al-lignin sample was crushed to fine powder (˜50-500 μm) and are labeled as P27.

### Preparation of LiAl-Lignin and NaB-Lignin (Examples 12-13)

### Example 12

Sodium (Na)-Boron (B) lignin (NaB-lignin) was prepared by mixing lignin powder and an aqueous solution of sodium hydroxide and boric acid. 715 grams of kraft lignin (provided by Domtar, 30% moisture) was first added to a 2000 mL glass beaker. 88.73 grams of sodium hydroxide (NaOH) and 115.66 grams of boric acid (B(OH)3) were added to 500 mL DI water in a 1000 mL glass beaker and heated and stirred at 80° C. for 30 minutes. The NaOH—B(OH)₃ solution was added to the lignin powder and mixed well to form a paste-like mixture. The NaB-lignin sample was dried in an oven at 100° C. overnight. The dried NaB-lignin sample was crushed to fine powder (˜50-500 μm) and are labeled as P28.

### Example 13

Lithium-aluminum lignin (LiAl-lignin) was prepared by mixing lignin powder and an aqueous solution of lithium hydroxide and aluminum hydroxide. 715 grams of kraft lignin (provided by Domtar, 30% moisture) was first added to a 2000 mL glass beaker. 52.82 grams of lithium hydroxide (LiOH) and 168.59 grams of aluminum hydroxide (Al(OH)₃) were added to 500 mL DI water in a 1000 mL glass beaker and heated and stirred at 80° C. for 30 minutes. The LiOH-Al(OH)₃ solution was added to the lignin powder and mixed well to form a paste-like mixture. The LiAl-lignin sample was dried in an oven at 100° C. overnight. The dried LiAl-lignin sample was crushed to fine powder (˜50-500 μm) and was labeled as P29.

### Metallized Biomass Prepared With Black Liquor (Examples 14-15)

### Example 14

One thousand (1000) milliliters of black liquor from kraft pulp mills (containing about 500 grams of kraft lignin) was dried in an oven at 100° C. overnight. The dried black liquor sample was crushed to fine powder (˜50-500 μm) and was labeled as P30.

### Example 15

85 grams of boric acid (B(OH)₃) was added to 1000 mL black liquor from kraft pulp mills (containing about 500 grams of kraft lignin) in a 2000 mL glass beaker and the mixture was heated and stirred at 80° C. for 30 minutes. The mixture was dried in an oven at 100° C. overnight. The dried sample was crushed to fine powder (˜50-500 μm) and was labeled as P31.

### Metallized Biomass Prepared With Other Biomass Feedstocks (Examples 16-18)

### Example 16

62.11 grams of sodium hydroxide (NaOH) was added to 300 mL DI water in a 500 mL glass beaker and the NaOH mixture was stirred until the solid dissolved completely. To the sodium hydroxide solution was added 500 g wood char (obtained from a fast pyrolysis process), followed by stirring the mixture for 0.5 hours. The Na-char mixture was kept at room temperature for 24 h, and then oven-dried at 100° C. for one day. The dried Na-char sample was crushed to fine powder (˜50-500 μm) and was labeled as P32.

### Example 17

88.04 grams of lithium hydroxide (LiOH) was dissolved in 500 mL DI water, followed by adding 500 grams of sugar (either glucose, xylose, arabinose, galactose, mannose, cellulose, hemicellulose, starch or a mixture of sugars from biomass hydrolysis). The LiOH-sugar mixture was stirred for 30 minutes and then transferred to an oven heated to 180-200° C. for 8 hrs. After heating, a black product was collected and ground to fine powder and was labeled as P33.

### Example 18

50 grams of sodium hydroxide (NaOH) was added to 300 mL DI water in a 500 mL glass beaker and the NaOH mixture was stirred until the solid dissolved completely. To the sodium hydroxide solution was added 500 g pine wood chips (˜1-5 mm). The NaOH-wood mixture was stirred for 30 minutes and then transferred into an oven to heat at 110° C. overnight. The dried sample was then exposed to a muffle furnace at 200-250° C. for 2 hrs. After heating, a black product was collected and grounded to fine powder and was labeled as P34.

### Metal (Atomic)-Carbon Composite Bodies

### Preparation of Open Sodium-Carbon Composite Bodies (Example 19)

300 grams of each of P1-P19 samples (Examples 1-3) were transferred to respective containers of stainless-steel molds. The samples were cold pressed using a hydraulic press to pressures of between 100 psi and 25,000 psi for times of between 5-60 seconds. Then, the compressed samples within their respective containers were transferred to a heating chamber. Argon gas was introduced into the heating chamber. The heating chamber was then heated at a heating rate of from about 0.1 to 10° C./min up to a temperature of about 350-500° C. and held at this temperature for 10 to 30 minutes. Next, the heating chamber was further heated with a heating rate of from about 1 to 5° C./min up to a temperature of about 750-1200° C. and held at this temperature for 0.5-3 hours to achieve carbonization. The carbonized samples in the containers were then cooled to room temperature at a rate of less than about 10° C./min under an argon atmosphere. The resulting Na—C composite bodies were flammable upon exposure to air. Therefore, the Na—C composite bodies were transferred under inert atmosphere and stored in kerosene or mineral oil. These Na—C composite bodies were labeled as Na—C—O (open) 1-19. The “O” indicates that the Na—C composite bodies are “open” as they were carbonized without an added source of gaseous hydrocarbons during carbonization.

### Comparative Example 20

300 grams of sample P5 (Example 1) was transferred to a heating chamber. No compression step was used. Nitrogen or argon gas was introduced into the heating chamber. The heating chamber was then heated at a heating rate of from about 0.1 to 10° C./min up to a temperature of about 350-500° C. and held at this temperature for 10 to 30 minutes. Next, the heating chamber was further heated with a heating rate of from about 1 to 5° C./min up to a temperature of about 750-1200° C. and held at this temperature for 0.5-3 hours to achieve carbonization. The carbonized samples in the containers were then cooled to room temperature at a rate of less than about 10° C./min under an argon atmosphere. The black powder product was transferred under inert atmosphere and stored in kerosene or mineral oil. The black powder product was labeled as Na—C—O-NoPress1. Notably, the Na content of Na—C—O-NoPress1 (3.2 wt%) is over 4 times less than the Na content of its compressed counterpart, Na—C—O 5.

TABLE 2
Properties of samples from Example
19 and Comparative Example 20.

| | Metallized | Density | Porosity | Na content |
|---|---|---|---|---|
| Sample | Biomass Sample | (g/cm³) | (%) | (wt %) |
| Na—C—O 1 | P1 | 0.33 | 76.2 | 2.6 |
| Na—C—O 2 | P2 | 0.35 | 73.5 | 5.5 |
| Na—C—O 3 | P3 | 0.38 | 69.8 | 8.3 |
| Na—C—O 4 | P4 | 0.41 | 66.2 | 11.6 |
| Na—C—O 5 | P5 | 0.45 | 63.8 | 14.2 |
| Na—C—O 6 | P6 | 0.48 | 61.5 | 17.5 |
| Na—C—O 7 | P7 | 0.50 | 59.3 | 20.3 |
| Na—C—O 8 | P8 | 0.53 | 56.6 | 23.6 |
| Na—C—O 9 | P9 | 0.55 | 53.1 | 25.8 |
| Na—C—O 10 | P10 | 0.56 | 50.2 | 27.4 |
| Na—C—O 11 | P11 | 0.49 | 60.2 | 17.1 |
| Na—C—O 12 | P12 | 0.50 | 59.1 | 17.4 |
| Na—C—O 13 | P13 | 0.52 | 57.8 | 17.6 |
| Na—C—O 14 | P14 | 0.55 | 56.9 | 17.7 |
| Na—C—O 15 | P15 | 0.73 | 46.1 | 17.9 |
| Na—C—O 16 | P16 | 0.41 | 65.5 | 10.2 |
| Na—C—O 17 | P17 | 0.38 | 70.3 | 9.5 |
| Na—C—O 18 | P18 | 0.63 | 50.6 | 29.3 |
| Na—C—O 19 | P19 | 0.60 | 52.1 | 10.5 |
| Na—C—O- | P5 | 0.39 | 72.0 | 3.2 |
| NoPress1 | | | | |

### Preparation of Sealed Sodium-Carbon Composite Bodies (Example 21)

300 grams of P1-P19 samples (Examples 1-3) were each transferred to respective containers of stainless-steel molds. The samples were cold pressed using a hydraulic press to pressures of between 100 psi and 25,000 psi for times of between 5-60 seconds. Then, the compressed samples within their respective containers were transferred to a heating chamber. Argon gas was introduced into the heating chamber. The heating chamber was then heated at a heating rate of from about 0.1 to 10° C./min up to a temperature of about 350-450° C. and held at this temperature for 10 to 30 minutes. Next, the argon flow was switched to an Ar—CH₄ gas flow, and the heating chamber was further heated with a heating rate of from about 0.5 to 5° C./min up to 750-1200° C. and kept at this temperature for 1-5 hours to achieve carbonization. The carbonized samples in the containers were then cooled to room temperature at a rate of less than about 10° C./min under an argon atmosphere. By contrast to the Na—C composite bodies of Example 19, the Na—C composite bodies of this Example 21 were not flammable upon exposure to air. This is believed to be due to the deposition of carbon within and on the Na—C composite body due to the decomposition of methane during the carbonization. This deposited carbon effectively seals the Na—C composite body preventing air, moisture, CO₂, and other reactive agents from penetrating the Na—C composite body. The Na—C composite bodies of this Example 21 were labeled as Na—C—S (sealed) 1-19. The “S” indicates that the Na—C composites are “sealed” as they were carbonized with an added source of gaseous hydrocarbons during carbonization. The use of the added source of gaseous hydrocarbons further increases the Na content of the Na—C—S composite bodies as compared to the Na—C—O composite bodies.

### Comparative Example 22

300 grams of sample P10 (Example 1) was transferred to a heating chamber. No compression step was used. Nitrogen or argon gas was introduced into the heating chamber. The heating chamber was then heated at a heating rate of from about 0.1 to 10° C./min up to a temperature of about 350-500° C. and held at this temperature for 10 to 30 minutes. Next, the argon flow was switched to an Ar—CH₄ gas flow, and the heating chamber was further heated with a heating rate of from about 0.5 to 5° C./min up to 750-1200° C. and kept at this temperature for 0.5-3 hours. The carbonized sample in the containers was then cooled to room temperature at a rate of less than about 10° C./min under an argon atmosphere. Like the Na—C composite bodies of Example 21, the Na—C composite bodies of this Comparative Example 22 are not flammable upon exposure to air. Again, this is believed to be due to the deposition of carbon within and on the Na—C composite body due to the decomposition of methane during carbonization. The Na—C composite bodies of this Comparative Example 22 is labeled as Na—C—S-NoPress1. It is noted that because no compression step was used, the Na content of Na—C—S-NoPress1 is less than its counterpart which made use of a compression step (see Na—C—S 10 in Table 3).

TABLE 3
Properties of samples from Example
21 and Comparative Example 22.

| | Metallized | Density | Porosity | Na content |
|---|---|---|---|---|
| Sample | Biomass Sample | (g/cm³) | (%) | (wt %) |
| Na—C—S 1 | P1 | 0.39 | 56.8 | 3.1 |
| Na—C—S 2 | P2 | 0.41 | 54.1 | 6.5 |
| Na—C—S 3 | P3 | 0.43 | 52.6 | 9.2 |
| Na—C—S 4 | P4 | 0.45 | 49.5 | 13.0 |
| Na—C—S 5 | P5 | 0.48 | 45.9 | 15.7 |
| Na—C—S 6 | P6 | 0.53 | 42.8 | 18.3 |
| Na—C—O 7 | P7 | 0.54 | 40.3 | 21.2 |
| Na—C—S 8 | P8 | 0.56 | 38.5 | 25.5 |
| Na—C—S 9 | P9 | 0.58 | 36.2 | 27.3 |
| Na—C—S 10 | P10 | 0.59 | 34.2 | 30.7 |
| Na—C—S 11 | P11 | 0.54 | 60.2 | 17.1 |
| Na—C—S 12 | P12 | 0.55 | 59.1 | 18.2 |
| Na—C—S 13 | P13 | 0.57 | 57.8 | 18.1 |
| Na—C—S 14 | P14 | 0.59 | 56.9 | 18.5 |
| Na—C—S 15 | P15 | 0.79 | 46.1 | 18.9 |
| Na—C—S 16 | P16 | 0.45 | 65.5 | 12.8 |
| Na—C—S 17 | P17 | 0.44 | 70.3 | 10.3 |
| Na—C—S 18 | P18 | 0.66 | 50.6 | 34.2 |
| Na—C—S 19 | P19 | 0.63 | 52.1 | 11.8 |
| Na—C—S- | P10 | 0.65 | 20.8 | 25.7 |
| NoPress1 | | | | |

### Preparation of Li-Carbon Composite Bodies (Example 23)

300 grams of Li-lignin P20 sample (Example 4) was mixed with 20 g polyacrylonitrile (PAN) powder, the mixture was ball-milled for 30 minutes and transferred to the container of a stainless-steel mold. The sample was then was cold pressed using a hydraulic press to pressures of between 100 psi and 25,000 psi for times of between 5-60 seconds. Then, the compressed sample within its container was transferred to a heating chamber. Argon gas was introduced into the heating chamber. The heating chamber was then heated at a heating rate of from about 0.1 to 10° C./min up to a temperature of about 350-450° C. and held for 10 to 30 minutes. Next, the argon flow was switched to an Ar—CH₄ gas flow, and the heating chamber was further heated with a heating rate of from about 0.5 to 5° C./min up to 750-1200° C. and kept at this temperature for 1-5 hours. The carbonized samples in the containers were then cooled to room temperature at a rate of less than about 10° C./min under an argon atmosphere. The resulting Li—C—S composite body sample can be stored in air as the use of the methane during carbonization deposits carbon on and within the body.

### Metal Conversion Treatment to Provide Metal Hydride (MH)-Carbon Composite Bodies

### Preparation of Open Sodium Hydride (NaH)-Carbon Composite Bodies (Example 24)

300 grams of P1-P19 samples (Examples 1-3) were each transferred to respective containers of stainless-steel molds. The samples were cold pressed using a hydraulic press to pressures of between 100 psi and 25,000 psi for times of between 5-60 seconds. Then, the compressed samples within their respective containers were transferred to a heating chamber. Argon gas was introduced into the heating chamber. The heating chamber was then heated at a heating rate of from about 0.1 to 10° C./min up to a temperature of about 350-500° C. and held at this temperature for 10 to 30 minutes. Next, the heating chamber was further heated with a heating rate of from about 1 to 10° C./min up to a temperature of about 750-1200° C. and held at this temperature for 0.5-3 hours to achieve carbonization. Next, the argon flow was switched to a H2 flow and the carbonized samples in the containers were then cooled to 600-750° C. at a rate of less than 10° C./min and kept at this temperature for 0.1 to 1 hours. Hydrogen reacts with sodium metal to convert the sodium metal throughout the composite body to sodium hydride (NaH). Next, the furnace was cooled to room temperature and the hydrogen flow was switched off to argon to purge the reactor chamber for 30 minutes. The NaH—C—O 1-19 composite bodies were transferred to respective containers under an inert atmosphere and sealed well.

### Preparation of Sealed Sodium Hydride-Carbon Composite Bodies (Example 25)

300 grams of P1-P19 samples (Examples 1-3) were each transferred to respective containers of stainless-steel molds. The samples were cold pressed using a hydraulic press to pressures of between 100 psi and 25,000 psi for times of between 5-60 seconds. Then, the compressed samples within their respective containers were transferred to a heating chamber. Argon gas was introduced into the heating chamber. The heating chamber was then heated at a heating rate of from about 0.1 to 10° C./min up to a temperature of about 350-450° C. and held at this temperature for 10 to 30 minutes. Next, the argon flow was switched to an Ar—CH₄ gas flow, and the heating chamber was further heated at a rate of from about 0.5 to 5° C./min up to 750-1200° C. and kept at this temperature for 0.5-3 hours. Next, the Ar—CH₄ gas flow was switched to an argon flow and the carbonized samples in the containers were then cooled to 600-750° C. at a rate of less than 10° C./min. Next, the argon flow was switched to a pure H₂ flow and kept at this temperature for 0.5 to 2 hours. During this time, the hydrogen pressure in the reactor chamber was adjusted between 1 psi to 30 psi. Next, the furnace was cooled to room temperature and the hydrogen flow was switched off to argon to purge the reactor chamber for 30 minutes. The NaH—C—S 1-19 composite bodies are able to be transferred and stored in air.

### Preparation of Open Lithium Hydride (LiH)-Carbon Composite Bodies (Example 26)

300 grams of Li-lignin P20 sample (Example 4) was mixed with 30 g kraft lignin powder (dried at 150° C. overnight) and then ball-milled (at 1000rpm) for 30 minutes and transferred to a container of a stainless-steel mold. The sample was cold pressed using a hydraulic press to pressures of between 100 psi and 25,000 psi for times of between 5-60 seconds. Then, the compressed sample within the container was transferred to a heating chamber. Argon gas was introduced into the heating chamber. The heating chamber was then heated at a heating rate of from about 1 to 10° C./min up to a temperature of 750-1200° C. and held at this temperature for 0.5 to 3 hours. Next, the sample was cooled to 600-700° C. under an argon flow at a cooling rate of from about 1 to 5° C./min. The argon flow was switched to a H₂ gas flow after the sample temperature reached 600-700° C. and kept at this temperature for 0.5 to 2 hours under the H₂ flow to convert the lithium metal to lithium hydride (LiH). Next, the furnace was cooled to room temperature and the hydrogen flow was switched off to argon to purge the reactor chamber for 30 minutes. The LiH—C—O composite body was transferred to a container under an inert atmosphere and sealed well.

### Preparation of Sealed Potassium Hydride-Carbon Composite Bodies (Example 27)

300 grams of K-lignin P21 sample (Example 5) was transferred to a container of a stainless-steel mold. The sample was cold pressed using a hydraulic press to pressures of between 100 psi and 25,000 psi for times of between 5-60 seconds. Then, the compressed sample within its respective container was transferred to a heating chamber. Argon gas was introduced into the heating chamber. The heating chamber was then heated at a heating rate of from about 0.1 to 10° C./min up to a temperature of about 350-450° C. and held at this temperature for 10 to 30 minutes. Next, the argon flow was switched to an Ar—CH₄ gas flow, and the heating chamber was further heated at a rate of from about 0.5 to 5° C./min up to 750-1200° C. and kept at this temperature for 0.5-3 hours. Next, the Ar—CH₄ gas flow was switched to an argon flow and the carbonized sample in the container was then cooled to 300-450° C. at a rate of less than 10° C./min. Then, the argon flow was switch to a pure H₂ flow and kept at this temperature for 0.5 to 2 hours. During this time, the hydrogen pressure in the reactor chamber was adjusted between 1 psi to 30 psi. Next, the furnace was cooled to room temperature and the hydrogen flow was switched off to argon to purge the reactor chamber for 30 minutes. The KH—C—S composite body is able to be transferred and stored in air.

### Preparation of Open Magnesium Hydride (MgH₂)-Carbon Composite Bodies (Example 28)

300 grams of Mg-lignin P24 sample (Example 8) with mixed with 30 g kraft lignin powder (dried at 150° C. overnight). The mixture was then ball-milled (at 1000 rpm) for 30 minutes and transferred to a container of a stainless-steel mold. The sample was cold pressed using a hydraulic press to pressures of between 100 psi and 25,000 psi for times of between 5-60 seconds. Then, the compressed samples within their respective containers were transferred to a heating chamber. Argon gas was introduced into the heating chamber. The heating chamber was then heated at a heating rate of from about 1 to 10° C./min up to a temperature of 750-1200° C. and held for 0.5 to 3 hours to achieve carbonization. Next, the sample was cooled to 300-400° C. under an argon flow at a cooling rate of from about 1 to 5° C./min. The argon flow was switched to a H₂ gas flow after the sample temperature had reached 300-400° C., and was kept at this temperature for 0.5 to 2 hours. Next, the furnace was cooled to room temperature and the hydrogen flow was switched off to argon to purge the reactor chamber for 30 minutes. The MgH₂—C—O composite body was transferred under an inert atmosphere and sealed well.

### Preparation of Sealed Calcium Hydride-Carbon Composite Bodies (Example 29)

300 grams of Ca-lignin P25 sample (Example 9) was transferred to a container of a stainless-steel mold. The sample was cold pressed using a hydraulic press to pressures of between 100 psi and 25,000 psi for times of between 5-60 seconds. Then, the compressed sample was transferred in the container to a heating chamber. Argon gas was introduced into the heating chamber. The heating chamber was then heated at a heating rate of from about 0.1 to 10° C./min up to a temperature of about 350-450° C. and held at this temperature for 10 to 30 minutes. Next, the argon flow was switched to an Ar—CH₄ gas flow, and the heating chamber was further heated at a rate of from about 0.5 to 5° C./min up to 750-1200° C. and kept at this temperature for 0.5-3 hours. Next, the Ar—CH₄ gas flow was switched to an argon flow and the carbonized sample in the container was then cooled to 650-800° C. at a rate of less than 10° C./min. Then, the argon flow is switch to a pure H2 flow and kept at this temperature for 0.5 to 2 hours. During this time, the hydrogen pressure in the reactor chamber was adjusted between 1 psi to 30 psi. Next, the furnace was cooled to room temperature and the hydrogen flow was switched off to argon to purge the reactor chamber for 30 minutes. The CaH₂—S composite bodies are able to be transferred and stored in air.

### Preparation of Open Sodium Borohydride (NaBH₄)-Carbon Composite Bodies (Example 30)

300 grams of NaB-lignin P28 sample (Example 12) was transferred to a container of a stainless-steel mold. The sample was cold pressed using a hydraulic press to pressures of between 100 psi and 25,000 psi for times of between 5-60 seconds. Then, the compressed sample within the container was transferred to a heating chamber. Argon gas was introduced into the heating chamber. The heating chamber was then heated at a heating rate of from about 0.1 to 10° C./min up to a temperature of about 350-500° C. and held at this temperature for 10 to 30 minutes. Next, the heating chamber was further heated with a heating rate of from about 1 to 5° C./min up to a temperature of about 750-1200° C. and held at this temperature to achieve carbonization. Next, the sample was cooled to 300-400° C. under an argon flow at a cooling rate of from about 1 to 5° C./min. The argon flow was switched to a H₂ gas flow after the sample temperature had reached 350-500° C., and was kept at this temperature for 0.5 to 2 hours. Next, the furnace was cooled to room temperature and the hydrogen flow was switched off to argon to purge the reactor chamber for 30 minutes. The NaBH₄—C—O composite body was transferred to a container under an inert atmosphere and sealed well.

### Preparation of Open Lithium Aluminum Hydride (LiAlH4)-Carbon Composite Bodies (Example 31)

300 grams of LiAl-lignin P29 sample (Example 13) was transferred to a container of a stainless-steel mold. The sample was cold pressed using a hydraulic press to pressures of between 100 psi and 25,000 psi for times of between 5-60 seconds. Then, the compressed sample within the container was transferred to a heating chamber. Argon gas was introduced into the heating chamber. The heating chamber was then heated at a heating rate of from about 0.1 to 10° C./min up to a temperature of about 350-500° C. and held at this temperature for 10 to 30 minutes. Next, the heating chamber was further heated with a heating rate of from about 1 to 5° C./min up to a temperature of about 750-1200° C. and held at this temperature for one hour to achieve carbonization. Next, the sample was cooled to 300-400° C. under an argon flow at a cooling rate of from about 1 to 5° C./min. The argon flow was switched to a H₂ gas flow after the sample temperature had reached 150-300° C., and was kept at this temperature for 0.5 to 2 hours. Next, the furnace was cooled to room temperature and the hydrogen flow was switched off to argon to purge the reactor chamber for 30 minutes. The LiAlH₄—C—O composite body was transferred to a container under an inert atmosphere and sealed well.

### Metal Conversion Treatment to Provide Metal Hydroxide-Carbon Composite Bodies, Metal Carbonate-Carbon Composite Bodies, Metal Oxide-Carbon Composite Bodies, Metal Sulfide-Carbon Composite Bodies, and Metal Phosphide-Carbon Composite Bodies

### Preparation of Sodium Hydroxide (NaOH)-Carbon Composite Bodies (Example 32)

300 grams of Na-lignin P1-P19 samples (Examples 1-3) were each transferred to respective containers of stainless-steel molds. The samples were cold pressed using a hydraulic press to pressures of between 100 psi and 25,000 psi for times of between 5-60 seconds. Then, the compressed samples within their respective containers were transferred to a heating chamber. Argon gas was introduced into the heating chamber. The heating chamber was then heated at a heating rate of from about 0.1 to 10° C./min up to a temperature of about 350-500° C. and held at this temperature for 10 to 30 minutes. Next, the heating chamber was further heated with a heating rate of from about 1 to 10° C./min up to a temperature of about 750-1200° C. and held at this temperature for 0.5-3 hours to achieve carbonization. The heating chamber was cooled to room temperature and the argon flow was bubbled through a bottle with DI water for 30-60 minutes. The water vapor reacted with sodium metal, converting it to sodium hydroxide. The NaOH—C—O 1-19 composite bodies were transferred to a container under an inert atmosphere and sealed well.

### Preparation of Sodium Carbonate (Na₂CO₃)-Carbon Composite Bodies (Example 33)

300 grams of Na-lignin P1-P19 samples (Examples 1-3) were each transferred to respective containers of stainless-steel molds. The samples were cold pressed using a hydraulic press to pressures of between 100 psi and 25,000 psi for times of between 5-60 seconds. Then, the compressed samples within their respective containers were transferred to a heating chamber. Argon gas was introduced into the heating chamber. The heating chamber was then heated at a heating rate of from about 0.1 to 10° C./min up to a temperature of about 350-500° C. and held at this temperature for 10 to 30 minutes. Next, the heating chamber was further heated with a heating rate of from about 1 to 10° C./min up to a temperature of about 750-1200° C. and held at this temperature for 0.5-3 hours to achieve carbonization. The heating chamber was cooled to room temperature and the argon flow was switched to Ar—CO₂ flow for 30-60 minutes. The CO2 reacted with sodium metal, converting it to sodium carbonate. The Na₂(CO₃)—C—O 1-19 composite bodies were transferred to a container under an inert atmosphere and sealed well.

### Preparation of Sodium Oxide (NazO)-Carbon Composite Bodies (Example 34)

300 grams of Na-lignin P1-P19 samples (Examples 1-3) were each transferred to respective containers of stainless-steel molds. The samples were cold pressed using a hydraulic press to pressures of between 100 psi and 25,000 psi for times of between 5-60 seconds. Then, the compressed samples within their respective containers were to a heating chamber. Argon gas was introduced into the heating chamber. The heating chamber was then heated at a heating rate of from about 0.1 to 10° C./min up to a temperature of about 350-500° C. and held at this temperature for 10 to 30 minutes. Next, the heating chamber was further heated with a heating rate of from about 1 to 10° C./min up to a temperature of about 750-1200° C. and held at this temperature for 0.5-3 hours to achieve carbonization. The heating chamber was cooled to room temperature and the argon flow was switched to Ar-air flow for 30-60 minutes. O2 in the air reacted with sodium metal, converting it to sodium oxide. The Na₂O—C—O 1-19 composite bodies were transferred to a container under an inert atmosphere and sealed well.

### Preparation of Boron Sulfide (B₂S₃)-Carbon Composite Bodies (Example 35)

300 grams of B-lignin sample P26 (Example 10) was mixed with 30 g kraft lignin powder (dried at 150° C. overnight) and the mixture was then ball-milled (at 1000 rpm) for 30 minutes and transferred to a container of a stainless-steel mold. The sample was cold pressed using a hydraulic press to pressures of between 100 psi and 25,000 psi for times of between 5-60 seconds. Then, the compressed sample within its container was transferred to a heating chamber. Argon gas was introduced into the heating chamber. The heating chamber was then heated at a heating rate of from about 1 to 10° C./min up to a temperature of 900-1200° C. and held for 0.5 to 3 hours to achieve carbonization. Next, the heating chamber was cooled to 450-600° C. under an argon flow at a cooling rate of from about 1 to 5° C./min. The argon flow was switched to an Ar—H₂S gas flow after the sample temperature had reached 450-600° C., and was kept at this temperature for 0.5 to 1 hours. The hydrogen sulfide reacted with the boron metal, converting it to boron sulfide (B₂S₃). The heating chamber was cooled to room temperature and the hydrogen sulfide flow was switched to argon flow to purge the reactor chamber for 30 minutes. The B₂S₃—C—O composite body was transferred to a container under an inert atmosphere and sealed well.

### Preparation of Boron Phosphide (BP)-Carbon Composite Bodies (Example 36)

300 grams of B-lignin sample P26 (Example 10) was mixed with 30 g kraft lignin powder (dried at 150° C. overnight) and the mixture was then ball-milled (at 1000 rpm) for 30 minutes and transferred to a container of a stainless-steel mold. The sample was cold pressed using a hydraulic press to pressures of between 100 psi and 25,000 psi for times of between 5-60 seconds. Then, the compressed sample within its container was transferred to a heating chamber. Argon gas was introduced into the heating chamber. The heating chamber was then heated at a heating rate of from about 1 to 10° C./min up to a temperature of 900-1200° C. and held for 0.5 to 3 hours to achieve carbonization. Next, the heating chamber was cooled to 800-900° C. under an argon flow at a cooling rate of from about 1 to 5° C./min. Then phosphorus vapor was brought into the reactor along with the argon flow after the sample temperature had reached 800-900° C. and was kept at this temperature for 0.5 tol hours. The phosphorus reacted with the boron metal, converting it to boron phosphide (BP). The heating chamber was then cooled to room temperature under argon flow. The BP—C—O composite body was transferred to a container in air.

### Metal Conversion Treatment to Provide Metal Nitride-Carbon Composite Bodies

### Preparation of Open Lithium Nitride (Li₃N)-Carbon Composite Body (Example 37)

300 grams of Li-lignin sample P20 (Example 4) was mixed with 30 g kraft lignin powder (dried at 150° C. overnight) and the mixture was then ball-milled (at 1000 rpm) for 30 minutes and transferred to a container of a stainless-steel mold. The sample was cold pressed using a hydraulic press to pressures of between 100 psi and 25,000 psi for times of between 5-60 seconds. Then, the compressed sample within its container was transferred to a heating chamber. Argon gas was introduced into the heating chamber. The heating chamber was then heated at a heating rate of from about 1 to 10° C./min up to a temperature of 750-1200° C. and held for 0.5 to 3 hours to achieve carbonization. Next, the heating chamber was cooled to 600-700° C. under an argon flow at a cooling rate of from about 1 to 5° C./min. The argon flow was switched to a N₂ gas flow after the sample temperature had reached 600-700° C., and was kept at this temperature for 10 to 30 minutes. Nitrogen reacted with lithium metal to convert it to lithium nitride (Li₃N) in the porous structure of the carbon monolith. The heating chamber was then cooled to room temperature under the nitrogen flow. The Li₃N—C—O composite body was transferred to a container under nitrogen atmosphere and sealed well.

### Preparation of Beryllium Nitride (Be₃N₂)-Carbon Composite Body (Example 38)

300 grams of Be-lignin sample P23 (Example 7) was mixed with 30 g kraft lignin powder (dried at 150° C. overnight) and the mixture was then ball-milled (at 1000 rpm) for 30 minutes and transferred to a container of a stainless-steel mold. The sample was cold pressed using a hydraulic press to pressures of between 100 psi and 25,000 psi for times of between 5-60 seconds. Then, the compressed sample within its container was transferred to a heating chamber. Argon gas was introduced into the heating chamber. The heating chamber was then heated at a heating rate of from about 1 to 10° C./min up to a temperature of 1000-1200° C. and held for 0.5 to 1 hours to achieve carbonization. The argon flow was switched to a N2 gas flow at this temperature for 10 to 60 minutes. Nitrogen reacted with beryllium metal to convert it to beryllium nitride (Be₃N₂). The heating chamber was cooled to room temperature under the nitrogen flow after the reaction completed. The Be₃N₂—C—O composite body was transferred to a container under nitrogen atmosphere and sealed well.

### Preparation of Magnesium Nitride (Mg₃N₂)-Carbon Composite Body (Example 39)

300 grams of Mg-lignin sample P24 (Example 8) was mixed with 30 g kraft lignin powder (dried at 150° C. overnight) and the mixture was then ball-milled (at 1000 rpm) for 30 minutes and transferred to a container of a stainless-steel mold. The sample was cold pressed using a hydraulic press to pressures of between 100 psi and 25,000 psi for times of between 5-60 seconds. Then, the compressed sample within its container was transferred to a heating chamber. Argon gas was introduced into the heating chamber. The heating chamber was then heated at a heating rate of from about 1 to 10° C./min up to a temperature of 800-1200° C. and held for 0.5 to 3 hours to achieve carbonization. Next, the heating chamber was cooled to 800-900° C. under an argon flow at a cooling rate of from about 1 to 5° C./min. The argon flow was switched to a N₂ gas flow at this temperature for 10 to 30 minutes. The nitrogen reacted with magnesium metal, converting it to magnesium nitride (Mg₃N₂). The heating chamber was cooled to room temperature under the nitrogen flow after the reaction completed. The Mg₃N₂—C—O composite body was transferred to a container under nitrogen atmosphere and sealed well.

### Preparation of Magnesium Nitride (Mg₃N₂)-Carbon Composite Body (Example 40)

300 grams of Mg-lignin sample P24 (Example 8) was mixed with 30 g kraft lignin powder (dried at 150° C. overnight) and the mixture was then ball-milled (at 1000 rpm) for 30 minutes and transferred to a container of a stainless-steel mold. The sample was cold pressed using a hydraulic press to pressures of between 100 psi and 25,000 psi for times of between 5-60 seconds. Then, the compressed sample within its container was transferred to a heating chamber. Argon gas was introduced into the heating chamber. The heating chamber was then heated at a heating rate of from about 1 to 10° C./min up to a temperature of 800-1200° C. and held for 0.5 to 3 hours to achieve carbonization. Next, the heating chamber was cooled to 700-800° C. under an argon flow at a cooling rate of from about 1 to 5° C./min. The argon flow was switched to Ar—NH₃ gas flow at this temperature for 10 to 60 minutes. NH₃ reacted with magnesium metal, converting it to magnesium nitride (Mg₃N₂). The heating chamber was cooled to room temperature under argon flow after the reaction completed. The Mg₃N₂—C—O composite body was transferred to a container under argon atmosphere and sealed well.

### Preparation of Boron Nitride (BN)-Carbon Composite Body (Example 41)

300 grams of B-lignin sample P26 (Example 10) was mixed with 30 g kraft lignin powder (dried at 150° C. overnight) and the mixture was then ball-milled (at 1000 rpm) for 30 minutes and transferred to a container of a stainless-steel mold. The sample was cold pressed using a hydraulic press to pressures of between 100 psi and 25,000 psi for times of between 5-60 seconds. Then, the compressed sample within its container was transferred to a heating chamber. Argon-ammonia (Ar—NH₃) gas was introduced into the heating chamber. The heating chamber was then heated at a heating rate of from about 1 to 10° C./min up to a temperature of 900-1200° C. and held for 0.5 to 2 hours to achieve carbonization. At the same time, NH₃ reacted with the boron metal, converting it to boron nitride (BN). The heating chamber was cooled to room temperature under nitrogen flow after the reaction completed. The BN—C—O composite body was transferred to a container in the air.

### Preparation of Aluminum Nitride (AIN)-Carbon Composite Body (Example 42)

300 grams of Al-lignin sample P27 (Example 11) was mixed with 30 g kraft lignin powder (dried at 150° C. overnight) and the mixture was then ball-milled (at 1000 rpm) for 30 minutes and transferred to a container of a stainless-steel mold. The sample was cold pressed using a hydraulic press to pressures of between 100 psi and 25,000 psi for times of between 5-60 seconds. Then, the compressed sample within its container was transferred to a heating chamber. Nitrogen gas was introduced into the heating chamber. The heating chamber was then heated at a heating rate of from about 1 to 10° C./min up to a temperature of 800-1200° C. and held for 0.5 to 3 hours to achieve carbonization. At the same time, N2 reacted with aluminum metal, converting it to aluminum nitride (AIN). The heating chamber was cooled to room temperature under argon flow after the reaction completed. The AIN—C—O composite body was transferred to a container under argon atmosphere and sealed well.

### Metal Conversion Treatment to Provide Metal Amide-Carbon Composite Bodies

### Preparation of Sodium Amide-Carbon Composite Bodies (Example 43-44)

### Example 43

300 grams of P1-P19 samples (Examples 1-3) were each transferred to respective containers of stainless-steel molds. The samples were cold pressed using a hydraulic press to pressures of between 100 psi and 25,000 psi for times of between 5-60 seconds. Then, the compressed samples were transferred in their respective containers to a heating chamber. Argon gas was introduced into the heating chamber. The heating chamber was then heated at a heating rate of from about 0.1 to 10° C./min up to a temperature of about 350-500° C. and held for 10 to 30 minutes. Next, the heating chamber was further heated with a heating rate of from about 1 to 5° C./min up to a temperature of about 750-1200° C. and held at this temperature for 0.5-3 hours to achieve carbonization. The samples were then cooled to room temperature at a rate of less than about 10° C./min under an argon atmosphere. At room temperature, the samples were transferred under inert atmosphere and soaked in liquid ammonia for 1-5 hours. The NH3 reacted with sodium metal, converting it to sodium amide and providing NaNH₂—C—O 1-19 composite bodies.

### Example 44

300 grams of P1-P19 samples (Examples 1-3) were each transferred to respective containers of stainless-steel molds. The samples were cold pressed using a hydraulic press to pressures of between 100 psi and 25,000 psi for times of between 5-60 seconds. Then, the compressed samples were transferred in their respective containers to a heating chamber. Argon gas was introduced into the heating chamber. The heating chamber was then heated at a heating rate of from about 0.1 to 10° C./min up to a temperature of about 350-500° C. and held for 10 to 30 minutes. Next, the heating chamber was further heated with a heating rate of from about 1 to 10° C./min up to a temperature of about 750-1200° C. and held at this temperature for 0.5-3 hours to achieve carbonization. Next, the carbonized samples in the containers were then cooled to 200-350° C. under an argon atmosphere. The Ar flow was switched to an Ar—NH₃ flow and kept at this temperature (200-350° C.) for 0.1 to 1 hours. The ammonia reacted with sodium metal, converting it to sodium amide (NaNH₂). The heating chamber was cooled to room temperature after the reaction completed and the Ar—NH₃ flow was switched off to argon to purge the reactor chamber for 30 minutes. The NaNH₂—C—O 1-19 composite bodies were transferred to a container under an inert atmosphere and sealed well.

### Preparation of 3D Lithium Amide (LiNH₂)-Carbon Composite Body (Example 45)

300 grams of Li-lignin P20 sample (Example 4) was transferred to a container of a stainless-steel mold. The sample was cold pressed using a hydraulic press to pressures of between 100 psi and 25,000 psi for times of between 5-60 seconds. Then, the compressed sample was transferred in its container to a heating chamber. Argon gas was introduced into the heating chamber. The heating chamber was then heated at a heating rate of from about 0.1 to 10° C./min up to a temperature of about 350-500° C. and held for 10 to 30 minutes. Next, the heating chamber was further heated with a heating rate of from about 1 to 10° C./min up to a temperature of about 750-1200° C. and held at this temperature for 0.5-3 hours to achieve carbonization. Next, the carbonized sample in the container was then cooled to 350-400° C. under an argon atmosphere. The Ar flow was switched to an Ar—NH₃ flow and kept at this temperature (350-400° C.) for 0.1 to 1 hours. Ammonia reacted with lithium metal, converting it to =lithium amide (LiNH₂) The heating chamber was cooled to room temperature after the reaction completed and the Ar—NH₃ flow was switched off to argon to purge the reactor chamber for 30 minutes. The LiNH₂—C—O composite body was transferred to a container under an inert atmosphere and sealed well.

### Preparation of Potassium Amide (KNH₂)-Carbon Composite Body (Example 46)

300 grams of K-lignin sample P21 (Example 5) was mixed with 30 g kraft lignin powder (dried at 150° C. overnight) and the mixture was then ball-milled (at 1000 rpm) for 30 minutes and transferred to a container of a stainless-steel mold. The sample was cold pressed using a hydraulic press to pressures of between 100 psi and 25,000 psi for times of between 5-60 seconds. Then, the compressed sample was transferred in its container to a heating chamber. Argon gas was introduced into the heating chamber. The heating chamber was then heated at a heating rate of from about 1 to 10° C./min up to a temperature of 750-1200° C. and held for 0.5 to 3 hours to achieve carbonization. Next, the heating chamber was cooled to 600-700° C. under an argon flow at a cooling rate of from about 1 to 5° C./min. The argon flow was switched to a H₂ gas flow after the sample temperature reached 300-400° C., and was kept at this temperature for 0.5 to 2 hours. The hydrogen reacted potassium metal to form potassium hydride (KH). The heating chamber was cooled to 250-350° C. and then the gas flow was switched to Ar—NH₃ gas flow and kept at this temperature (250-350° C.) for 0.1 to 1 hours. The ammonia reacted with potassium hydride (KH) to form potassium amide (KNH₂). The heating chamber was cooled to room temperature after the reaction completed and the Ar—NH₃ flow was switched off to argon to purge the reactor chamber for 30 minutes. The KNH₂—C—O composite body was transferred to a container under an inert atmosphere and sealed well.

### Electrodes Based on Metal-Carbon Composite Bodies

### Example 47

Finally, electrochemical tests were performed on a Na-carbon composite body formed according to Example 19 (Na—C—O-6) (Na amount of 17.5 weight %, calculated from metallization process). The results are shown in Table 4, below. Table 4 also includes the results for a comparative carbon body formed from unmetallized kraft lignin. The comparative carbon body has a Na amount of less than 1 weight %. The results show that the specific and areal capacitance of the Na-carbon composite body is substantially greater as compared to the comparative carbon body.

TABLE 4
Results of Electrochemical Tests.

| | Na | Specific Capacitance | | Areal Capacitance | |
|---|---|---|---|---|---|
| | amount | Cₛ (F/g) | | (mF/cm²) | |
| Sample | (wt %) | 5 mV/s | 10 mV/s | 2 mA/cm² | 5 mA/cm² |
| Na-carbon | 17.5 | 22.23 | 13.77 | 291.50 | 497.25 |
| Composite | | | | | |
| Body | | | | | |
| (Example 19) | | | | | |
| Comparative | 0.84 | 0.52 | 0.40 | 6 | 5 |
| Carbon Body | | | | | |

### Example 48

This Example describes additional characterization of a Na-carbon composite body formed according to the Examples above, including Example 19 (Na—C—O 3 “LCF #2”; Na—C—O-6 “LCF #3”; and Na—C—O 10 “LCF #4). Electrochemical tests using the Na-carbon composite bodies as supercapacitor electrodes were also performed. Characterization and electrochemical tests using a comparative carbon body formed from unmetallized kraft lignin (”LCF #1″) were also performed. Regarding the electrochemical tests, a thick freestanding electrode formed from LCF #3, composed of carbon (derived from lignin) and sodium without any binder and without any additives exhibited a specific areal capacitance of 19.7 F cm⁻² at a current density of 1 mA cm⁻². It is believed that the excellent electrochemical performance originates from high electro-positivity and high oxygen content as promoted by the sodium.

### Experimental Section/Methods

See Example 19 for the methods of forming the Na-carbon composite bodies.

Morphology, structure and composition characterizations: Morphology and composition of the Na-carbon composite bodies were characterized by scanning electron microscopy (SEM, Zeiss NVision 40 FIB/SEM) equipped with an energy dispersive X-ray (EDX) detector. Crystalline structure was characterized by XRD (Rigaku Ultima III, using Cu Kα radiation (λ=1.5406 Å)). N₂ adsorption/desorption method (Micromeritics ASAP 2020) was utilized to characterize pore size and surface area of the samples. The specific surface area was calculated by the BET method, the pore size distribution and average pore size were calculated by density functional theory (DFT) method. The content and configuration of carbon, oxygen, and sodium were analyzed by XPS (PHI Quanter XPS with Al Kα X-ray).

Electrode preparation for supercapacitors: The obtained Na-carbon composite body was cut and polished to the size of 6.5 mm×8.5 mm×2.55 mm (length×width×thickness) using 800˜2000 grit sandpapers to form the electrode. The prepared electrode was submerged in piranha solution with 3:1 of concentrated sulfuric acid (99.99%) to 30 wt. % hydrogen peroxide overnight to increase hydrophilicity. The sample was washed multiple times in deionized (DI) water until the pH reached approximately 7, before putting into a PTFE holder as working electrode for electrochemical testing. The acid and peroxide treatment, as well as subsequent exposure to air induces conversion of at least some sodium atoms in the electrode to sodium oxide, sodium hydroxide, and sodium carbonate.

Electrochemical characterization: An electrochemical workstation (Chi 600E, Chi Instruments) with three-electrode configuration in 6M KOH electrolyte was used to investigate the electrochemical properties. A platinum plate (10 mm × 10 mm) and a saturated calomel were used as counter electrode and reference electrode respectively. Cyclic voltammetry (CV) was carried out in potential window from −0.8 V to 0 V to investigate the capacitive behavior. The scan rates varied from 1 mV s⁻¹ to 20 mV s⁻¹. Similarly, galvanostatic charge-discharge (GCD) measurements were conducted with current densities increased from 1 mA cm⁻² to 100 mA cm⁻² to evaluate the areal capacitance of the electrodes. The electrochemical impedance spectrum (EIS) was examined at the open circuit potential with voltage amplitude of 5 mV, alternating current with frequency ranging from 0.01 Hz to 100 kHz. The areal and mass specific capacitances of the electrodes were calculated by following equations:

$${C}_{( a r e a l )} = \frac{I}{( dV / dt ) \cdot S}$$

$${C}_{( m a s s )} = \frac{I}{( dV / dt ) \cdot m}$$

where I is the discharge current (A), dV/dt is the average slope of the discharge curve after deducting the ohmic drop (V/s), S is the effective area of the electrode (cm²) and m is the mass of the electrode (g).

Zeta potential measurement: The zeta potential of the samples was measured using a Malvern Zetasizer at a pH of 7. The mono suspension was obtained by dispersing the pulverized LCF #1 and LCF #3 in ethanol using ultrasonic homogenizer.

### Results and Discussion

Na-carbon composite bodies were fabricated via controlled carbonization parameters with various concentrations of sodium. The sodium content was measured and found to be: <1 wt. % (LCF #1), 8 wt. % (LCF #2), 16 wt. % (LCF #3), and 28 wt. % (LCF #4). (See also Table 5 below). SEM images and EDS mapping was conducted for all samples (data not shown). As shown in FIGS. 4A and 4B, the SEM images revealed that the pores of LCF #1 were quite large, having sizes between 50 μm and 150 μm. The high magnification SEM image showed a smooth surface without significant volume defects. By contrast, as shown in FIGS. 4C and 4D, the SEM images of LCF #3 showed that the material has more of a particle-like morphology with particle sizes of from tens of nanometers to tens of micrometers. The difference in morphology is believed to be due to the high sodium content of LCF #3. Sodium ions can act as a catalyst for carbonization by promoting breakdown of lignin into carbon. The more sodium participates in the carbonization reactions, the smaller the carbon particles with nonuniform sizes will be obtained. Furthermore, sodium may form sodium carbonate at low temperatures, which may have a significant impact on the structure of carbon materials produced from lignin precursors. When temperature is elevated during the carbonization process, the carbonates can decompose into Na₂₀ and CO₂. CO₂ may react with carbon to form small pores while Na₂O may be reduced by carbon, forming vapors of sodium and further promoting formation of small pores. Both reaction mechanisms facilitate the generation of small particles and even smaller pores observed in FIGS. 4C and 4D. XPS analysis on LCF #1 and LCF #3 (before acid treatment) showed that a prominent carbonate peak was observed for the LCF #3 spectra whereas no such peak was evident in the LCF #1 spectra. The existence and structure of sodium compounds in LCF #3 is further discussed below with reference to the X-ray diffraction (XRD) and X-ray photoelectron spectroscopy (XPS) analyses.

The elemental composition and distribution of the samples were characterized by EDS mapping. Table 5, below, summarizes the elements and their atomic and weight percentages in the specimens. Each sample contains carbon, oxygen, sodium. Trace elements from lignin may be present, such as sulfur and aluminum from lignin. The small amount of sodium in LCF #1 is also from lignin due to the pulping process used to obtain the lignin. All elements are uniformly distributed throughout the specimens. The detected sodium atomic percentages in LCF #1 and LCF #3 are 0.45% and 10.34%, respectively, while the oxygen atomic percentages are 4.21% and 28.37%, respectively. As the oxygen content increases substantially when the percentage of sodium is increased, it suggests that most of sodium is not in atomic form, but in compound form, such as sodium oxide, sodium hydroxide, and sodium carbonate. This allows more oxygen to be trapped within the composite. A rich oxygen content can improve electrochemical properties by introducing additional surface functionalities and increasing the number of active sites for charge storage.

TABLE 5
Atomic and weight percentages of
each element in the LCF samples.

| | C | O | Na | S | C | O | Na | S |
|---|---|---|---|---|---|---|---|---|
| | at. % | at. % | at. % | at. % | wt. % | wt. % | wt. % | wt. % |
| LCF #1 | 94.94 | 4.21 | 0.45 | 0.25 | 92.69 | 5.47 | 0.84 | 0.66 |
| LCF #2 | 77.88 | 17.32 | 4.42 | 0.33 | 70.52 | 20.89 | 7.66 | 0.79 |
| LCF #3 | 60.53 | 28.37 | 10.34 | 0.76 | 50.38 | 31.45 | 16.47 | 1.69 |
| LCF #4 | 36.67 | 33.30 | 21.60 | 5.18 | 25.33 | 30.72 | 28.63 | 9.58 |

To fully understand the structure and surfaces of LCF #1 and LCF #3, XRD, Brunauer-Emmett-Teller (BET), and XPS analyses were performed. The XRD patterns for LCF #1 and LCF #3 are shown in FIG. 5A. The XRD peaks obtained around 25°, 43° and 78° can be respectively assigned to (002), (101) and (110) carbon planes. Unlike LCF #1, LCF #3 has multiple sharp peaks from 30° to 40°. The sharp peaks at 32°, 35° and 40° can be respectively assigned to (202), (120) and (441) crystallographic planes of hydrated sodium carbonates. FIGS. 5B and 5C show N₂ adsorption/desorption isotherms and pore size distribution respectively. LCF #1 contains pores within a range of 2.7 to 4 nm (in addition to the large pores shown in FIG. 4A). However, LCF #3 contains a greater number and broader distribution of pores within a range of from 2.5 to 10 nm. (See also FIG. 4C.) The greater porosity and broader range of small pores in LCF #3 may promote energy storage in the fabricated supercapacitors. Larger mesopores can provide access to the inner surface of the composite and facilitate diffusion of ions into smaller micropores, enabling faster charge-discharge rates. Smaller micropores also offer a high surface area for charge storage. The specific surface area (SSA) and pore volume of these samples were calculated. Pore volumes are shown in FIG. 5B. The SSA for LCF #1 and LCF #3 were 12.99 m² g⁻¹ and 64.19 m² g⁻¹, respectively, suggesting that the LCF #3 fabricated electrode will exhibit higher capacitance.

The surface elemental groups were investigated using XPS as shown in FIGS. 5D-5F. The full scale XPS survey of samples after acid treatment revealed the presence of C, Na, O and S (FIG. 5D). FIGS. 5E and 5F show the deconvoluted C1s spectra for LCF #1 and LCF #3, respectively. As shown in FIG. 5E, the C1s spectrum for LCF #1 can be deconvoluted into two Gaussian curves with peaks at 284.8 eV and 286.5 eV corresponding to C—C (sp²) and C—O, respectively. The C—O peak suggests the hydroxylation of the sample due to acid treatment, making it hydrophilic. In addition to C—C (sp²) and C—O peaks, LCF #3 shows two additional peaks at 283.0 eV and 286.7 eV, which can be ascribed to the binding energy of carbides and C—S respectively. Table 6, below shows bonds deconvoluted from C 1s and their percentages in LCF #1 and LCF #3. The oxygen-containing functional groups make up approximately 12% in LCF #3, which is almost double compared to that in LCF #1. The oxygen-containing functional groups will improve the interaction with an electrolyte in contact with LCF #3 and help to improve ion transport. The presence of approximately 4% of carbon-sulfur bonds in LCF #3 also provides additional active sites for electrochemical reactions and can improve the overall electrical conductivity of the carbon material. Additionally, sulfur can act as a redox-active element, enabling reversible electrochemical reactions to take place during the charge-discharge processes. The XPS spectra for sodium, oxygen, and sulfur are shown in FIGS. 5G-5I for LCF #3.

TABLE 6
Bonds deconvoluted from C 1s and their amounts
in LCF #1 and LCF #3.

| Bonds | C—C sp² | C—O | C—S | Carbide |
|---|---|---|---|---|
| Binding Energy (eV) | 284.8 | 286.5 | 286.7 | 283 |
| LCF #1 | 94.88% | 5.11% | 0 | 0 |
| LCF #3 | 84.98% | 11.30% | 3.48% | 0.23% |

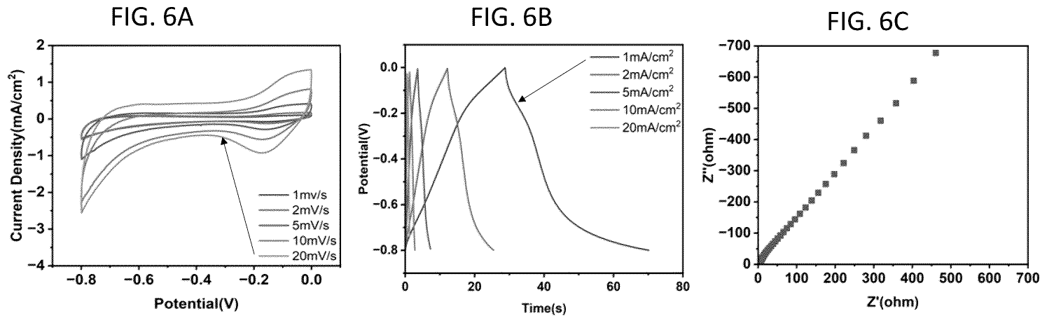

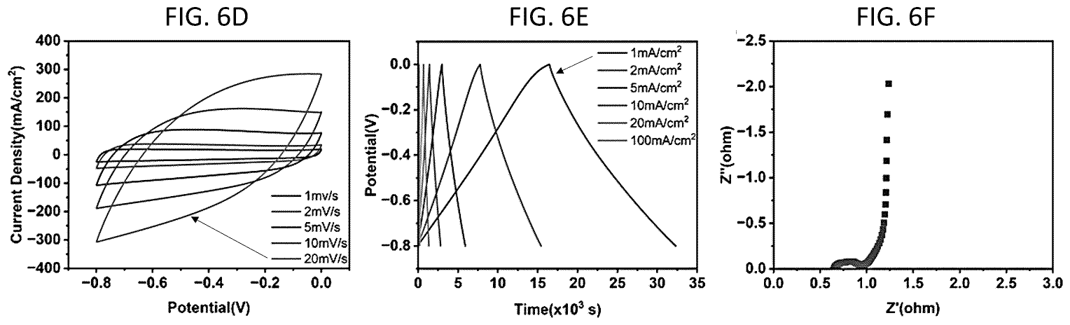

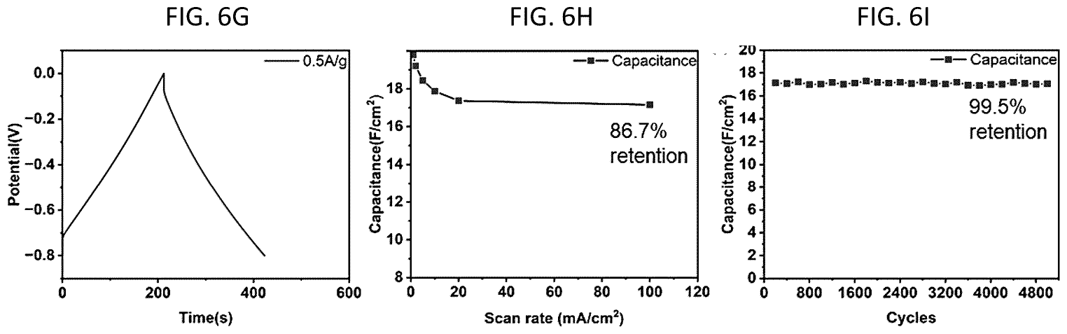

The electrochemical performance of the LCF #1 and LCF #3 as electrodes in a three-electrode system was measured. In this system, the respective LCF sample was used as the working electrode, a platinum sheet was used as a counter electrode, a commercial Ag/AgCl electrode was used as a reference electrode, and 6 M KOH solution was used as the electrolyte. The potential window was set from −0.8 to 0.0 V. The results are shown in FIGS. 6A-6I. FIG. 6A shows CV curves for LCF #1 at scan rates of 1-20 mV s⁻¹. Generally, carbon materials have near perfect rectangular CV curves, resulting from the electric double-layer capacitor (EDLC) charging and discharging mechanism. Additionally, the area enclosed between the curves indicates capacitive performance. For LCF #1, the area between the charging and discharging curves is very small, indicating poor capacitance. Furthermore, the curve is not perfectly rectangular. Instead, it contains two bumps, due to the presence of residual AgCl in the reference electrode, where the contribution to capacitance is negligible. FIG. 6B shows galvanometric charge discharge (GCD) curves for LCF #1 at different current densities. The curves exhibit in a distorted triangular shape, which could result from electrode polarization and/or irreversible reactions. Regarding electrode polarization, an accumulation of charge at the electrode surface due to a slow rate of charge transfer or lack of available surface area for the charge to distribute may lead to a non-linear charge-discharge curve, with the voltage dropping off more quickly than expected. As noted above, LCF #1 was shown to have a low surface area (SSA of only 12.99 m² g⁻¹) as compared to that of LCF #3 (SSA of 64.19 m² g⁻¹). When the electrochemical reactions taking place during charging and discharging are not completely reversible, this will bring a loss of capacity and distortion to the charge-discharge curve. The calculated value capacitance of LCF #1 from GCD is 0.052 F cm⁻² at a current density of 1 mA cm⁻². The electrochemical impedance spectrum (EIS) shown for LCF #1 shown in FIG. 6C shows 45-degree slanted curve, suggesting high Warburg resistance, and does not show any presence of semicircle in high frequency implying reduced capacitive behavior. Overall, FIGS. 6A-6C show that the electrochemical performance of LCF #1 is poor, which may be due to the reduced amount of micropores and suppressed SSA.

As shown in FIG. 6D, the CV curve for LCF #3 shows a nearly rectangular shape, strongly suggesting the presence of pseudocapacitive behavior along with the EDLC behavior, likely due to the presence of oxygen containing functional groups and sulfur compounds. As shown in FIG. 6E, LCF #3 also exhibits excellent charge-discharge efficiency, as signified by the near isosceles triangle shape of the GCD curve at different current densities. Importantly, the LCF #3 electrode also exhibits excellent areal capacitances of 19.78, 19.20, 18.43, 17.87 and 17.36 F cm⁻² at current densities of 1, 2, 5, 10, and 20 mA cm⁻², respectively. These values contribute to the superior electrochemical behavior of the LCF #3 electrode having a thickness of 2.5 mm and a high mass loading of 113 mg cm⁻². FIG. 6E also shows that the LCF #3 electrode has an excellent capacitance retention rate of 86.7% even at a high current density of 100 mA cm⁻². These values are believed to be among the highest of other electrodes with comparable thickness and mass loading. The occurrence of a very small iR drop (7.3 mV) further confirms the high-rate performance of the LCF #3 electrode. The Nyquist plot shown in FIG. 6F for LCF #3 shows a typical capacitive curve. The small semicircle is followed by a short 45-degree phase shift segment implying small Warburg resistance. Furthermore, an almost vertical line parallel to the real X-axis indicates strong EDLC behavior. The equivalent series resistance (ESR) of the LCF #3 electrode is as low as 1.15 ohm, enabling excellent ion transfer and conductivity. As shown in FIG. 6G, even with the high mass loading of 113 mg cm⁻², the gravimetric capacitance of the LCF #3 electrode is good: 145.74 F g⁻¹ at 0.5 A g⁻¹. These high area and gravimetric capacitances account for the high-power density supercapacitors by tuning the amount of sodium in the electrode. The LCF #3 electrode has a great charging and discharging stability as 99.5% of initial capacitance is retained after 5,000 cycles (FIG. 6I).

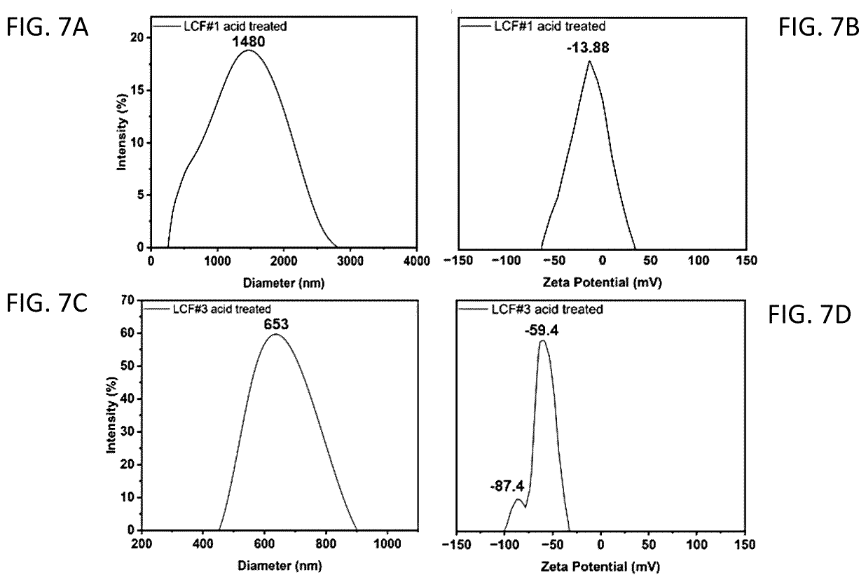

Electrochemical behavior refers to the chemical reactions that occur at the interface between an electrode and an electrolyte solution. The behavior of the electrode-electrolyte system is influenced by the concentration of ions in electrolyte, as well as the zeta potential of the electrode surface. To clearly understand the role of sodium in both LCF #1 and LCF #3 during electrochemical charging and discharging, the zeta potential was measured and the results are shown in FIGS. 7B (LCF #1) and 7D (LCF #3). The zeta potential for LCF #1 is −13.88 mV (FIG. 7B), whereas LCF #3 shows a more negative potential of −59.4 mV with a smaller peak at −87.4 mV (FIG. 7D). The higher negative zeta potential in LCF #3 can be attributed to the presence of sodium compounds and higher percentage of oxygen containing functional groups. As demonstrated with the EDS analysis described above, LCF #3 has a substantially greater sodium content than LCF #1. As a result, the concentration of OH⁻ increases in the Stern layer. This increase in ion concentration is easily accommodated in LCF #3 due to its greater number and broad distribution of small pores, which facilitates better ion diffusion and conduction. In addition, an increase in negative zeta potential value is believed to increase conductivity, which positively affects the capacitance of the material. Together the results demonstrate the excellent electrochemical capacitance of the LCF #3 electrode.

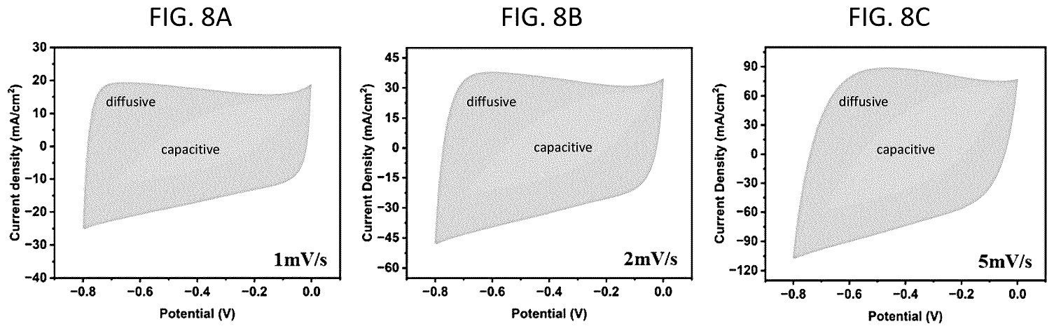

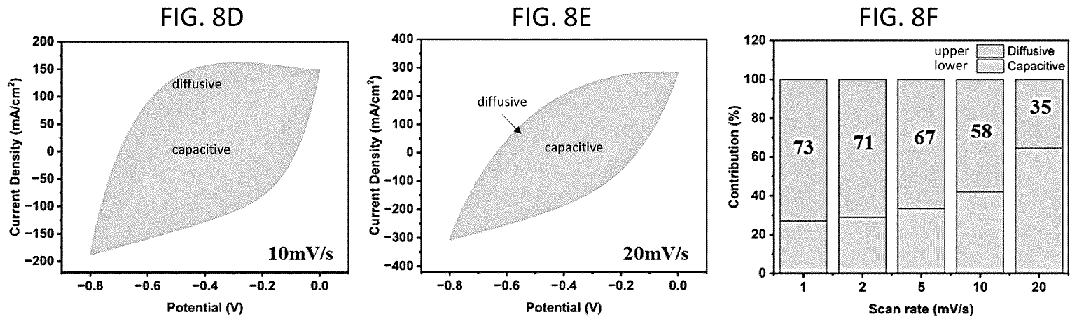

To quantify the role of hydroxyl group and sulfur compounds in overall capacitance in the LCF #3 electrode, the contribution of capacitive and diffusive capacitance on total capacitance for LCF #3 is shown in FIGS. 8A-8F. Specifically, the electrochemical kinetics of the LCF #3 electrode is investigated by measuring CV curves at scan rates from 1 mV s^{-b 1} to 20 mV s⁻¹. The contribution of the capacitive effect (pseudocapacitance) and diffusion-controlled capacity (EDLC) are quantitatively separated from the total charge storage based on Dunn's approach:

$$i ( V ) = {k}_{1} v + {k}_{2} {v}^{1 / 2}$$

The ratios of capacitive contribution can be calculated by separating the current response i at a fixed potential V into capacitive effects with a fast kinetics (proportional to the scan rate v) and diffusion-controlled reactions (k₂v^{1/2}). By determining both k₁ and k₂ constants, the fraction of the current from surface capacitance and K⁺ (potassium ion) semi-infinite linear diffusion can be distinguished. FIGS. 8A-8E show the typical voltage profile at different current densities for the diffusive current (outer region) in comparison with the total current. A dominant diffusive contribution (˜73%) is observed for the LCF #3 electrode at 1 mV s⁻¹ as shown in FIG. 8A. As the scan rate increases, the capacitive contribution (inner region) grows. The normalized contribution ratios of capacitive (lower portion) and diffusion-controlled (upper portion) capacities at various scan rates are summarized in FIG. 8F. The capacitive capacity grows to a maximum value of ˜65% at 20 mV s⁻¹, which is reasonable since the diffusion-controlled EDLC originates from the electrostatic adsorption of charge-separated anions and cations. The charge separation is a slow electrochemical process compared with the pseudocapacitive faradaic reaction.

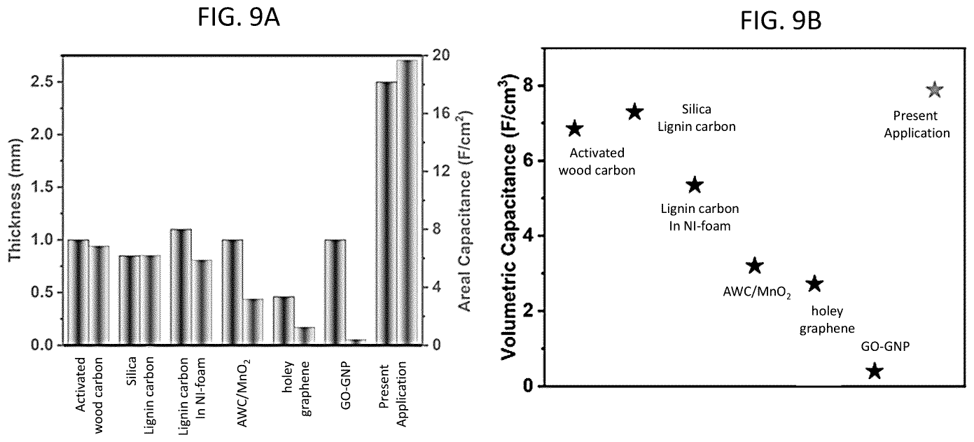

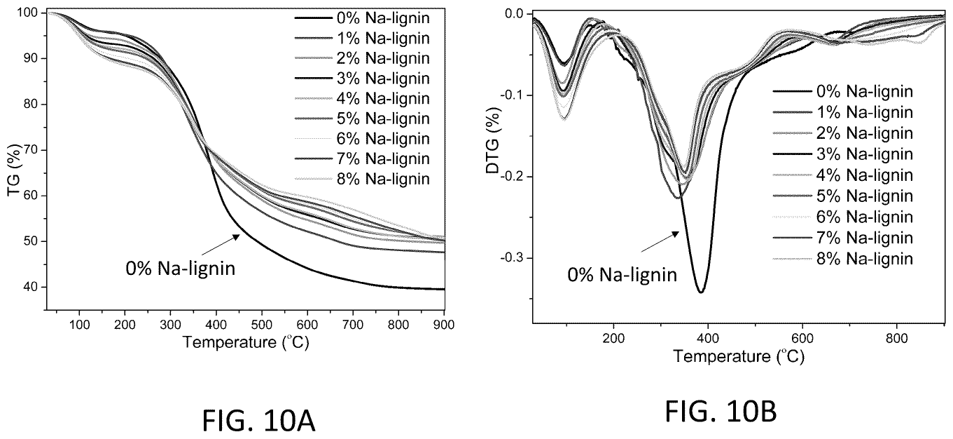

To demonstrate the advantage of coupling lignin carbon and alkali metals, FIG. 9A compares the electrochemical capacitance (right bars and right axis) of LCF #3 to previously reported data on different carbon materials with various thicknesses (left bars and left axis). The freestanding, thick LCF #3 electrode free of any binder and additives has the highest specific areal capacitance of 19.7 F cm⁻² at a current density of 1 mA cm⁻². To account for thickness, the areal capacitance was normalized by dividing by thickness to get volumetric capacitance, which is shown in FIG. 9B. This confirms that the LCF #3 electrode exhibits superior capacitance as compared to existing electrode materials.

### Conclusions

In summary, this Example describes an important pathway to utilize biowaste lignin for advanced energy storage applications. Freestanding 3D thick electrodes were fabricated from sodium metallized lignin. Sodium plays a key role in dictating surface morphology and chemical properties of the electrodes, which promotes the concentration of the OH″ ion in the Stern layer, thus contributing to excellent capacitive performance. The as-synthesized freestanding 3D lignin/sodium electrode exhibits an exceptional specific areal capacitance of 19.7 F cm⁻² at a current density of 1 mA cm⁻² along with good specific mass capacitance of 145.74 F g⁻¹ at 0.5 A g⁻¹ with mass loading of 113 mg cm⁻². The superior electrochemical performance of the lignin/sodium electrode is further demonstrated by its outstanding retention rate of 86.7% at 100 mA cm⁻² and a great cyclic stability (99.5%).

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

What is claimed is:

1. A method of forming a metal-carbon composite body, the method comprising:
(a) subjecting a metallized biomass to pressure for a period of time to provide a compressed metallized biomass body, wherein the metallized biomass comprises a metallized biopolymer comprising a hydrocarbon backbone and a plurality of metallized functional groups distributed along the hydrocarbon backbone and covalently bound thereto; and
(b) heating the compressed metallized biomass body according to a heating profile to carbonize the compressed metallized biomass body and provide a metal-carbon composite body comprising a covalently bound carbon matrix that extends in three dimensions to form a three-dimensional (3D) carbon network with metal distributed throughout the 3D carbon network.

2. The method of claim 1, wherein the metallized biopolymer comprises metallized lignin.

3. The method of claim 1, wherein the metallized functional groups have formula —OM, wherein M is the metal.

4. The method of claim 1, wherein the metallized functional groups comprise a metal selected from alkali metals.

5. The method of claim 1, wherein the metallized functional groups comprise Na.

6. The method of claim 1, the method further comprising forming the metallized biomass by combining biomass comprising a biopolymer comprising the hydrocarbon backbone and a plurality of biomass functional groups distributed along the hydrocarbon backbone and covalently bound thereto, and a source of metal cations under conditions to induce reactions between the plurality of biomass functional groups and the metal cations to provide the plurality of metallized functional groups of the metallized biopolymer.

7. The method of claim 6, wherein the source of the metal cations is a metal hydroxide.

8. The method of claim 6, wherein the biomass and the source of metal cations are provided in a liquid medium.

9. The method of claim 8, wherein the liquid medium comprises water.

10. The method of claim 6, wherein the biomass is lignin, the metal cations comprise Na, and the biomass and the source of metal cations are provided in a liquid medium comprising water.

11. The method of claim 10, wherein the lignin is kraft lignin.

12. The method of claim 1, the method further comprising exposing the metal-carbon composite body to a reactant under conditions to induce a reaction between the metal and reactant to convert the metal to a metal-containing compound.

13. The method of claim 12, wherein the metal-containing compound is a metal hydroxide, a metal oxide, a metal carbonate, or combinations thereof.

14. The method of claim 1, wherein the metal forms a 3D metallic network intertwined with the 3D carbon network.

15. The method of claim 1, wherein the 3D carbon network defines a plurality of pores distributed throughout that are at least partially filled with the metal.

16. The method of claim 15, wherein a majority of pores in the 3D carbon network have a cross-sectional diameter of less than 100 nm.

17. The method of claim 16, wherein the 3D carbon network is free of pores having a cross-sectional diameter of greater than 200 mm.

18. The method of claim 1, wherein the metal is present at an amount of at least 10 weight % as compared to a total weight of the metal-carbon composite body.

19. A metal-carbon composite body comprising a covalently bound carbon matrix that extends in three dimensions to form a three-dimensional (3D) carbon network with metal distributed throughout the 3D carbon network, wherein the metal forms a 3D metallic network intertwined with the 3D carbon network.

20. An electrochemical device comprising an electrode comprising the metal-carbon composite body of claim 19.
